(19) United States
(12) Patent Application Publication
(10) Pub. No.: US 2002/0062367 A1
(43) Pub. Date: May 23, 2002

(54) Opportunity tracking information system

(76) Inventors: J. Dale Debber, Grass Valley, CA (US); Russell D. Ribb, Fresno, CA (US)

Correspondence Address: FENWICK & WEST LLP, TWO PALO ALTO SQUARE, PALO ALTO, CA, 94306, US

(21) Appl. No.: 09/771,133

(22) Filed: Jan. 26, 2001

Related U.S. Application Data
(60) Provisional application No. 60/178,168, filed on Jan. 26, 2000.

(51) Int. Cl. G06F 15/173; H04B 1/38

(52) U.S. Cl. 709/224; 455/134; 455/135

(57) ABSTRACT

A communication network system includes a plurality of client computers communicatively coupled to a network, which in turn is coupled to one or more server computers and at least one database. A method for reviewing and tracking workflow tasks, anomalies and other information using the system provides real-time access of the status of tasks and projects on a continuing basis. Individuals interact with the system to provide updates to the status of tasks. The system automatically escalates the completion of an overdue task or anomaly that has failed to be completed within a predetermined time period.

### CROSS-REFERENCE TO RELATED APPLICATION

This application claims priority under 35 U.S.C §119(e) from co-pending U.S. Provisional Application No. 60/178,168, filed on Jan. 26, 2000 by J Dale Debber, et al., entitled “Opportunity Tracking Information System,” the subject matter of which is fully incorporated herein by reference.

### FIELD OF THE INVENTION

The present invention relates generally to communication network systems, and more particularly to a system, method and computer medium, for identifying, tracking and managing the completion of tasks to achieve improved process-flow performance.

### BACKGROUND OF THE INVENTION

The complexity, size and distribution of many organizations (including businesses) are ever increasing and changing. The rapid growth in size and complexity of an organization typically leads to a large number of tasks (i.e., processes) that must be accomplished in a timely manner for any organization to be successful. The tasks may vary in scope based upon the context of the situation. For example, the tasks may include routine administrative matters, customer service requests, specific projects, manufacturing steps, and business and other related service-type processes. A common aspect amongst these tasks is that they are performance-driven, frequently measured by the timely completion of milestones along with the appropriate level of quality assurance. Conventional techniques have failed to effectively address the change in dynamics of an organization, whereupon the increasing complexity and quantity of tasks undertaken require effective and efficient management integrated seamlessly into the process flow.

Additionally, there is a growing trend where organizations are increasing and dispersing their workforce in the market place to enable them to be closer to their customers; however, the organizations are simultaneously facing significant labor shortages. The difficulty in finding qualified personnel to fill various positions within an organization frequently leads to an accommodation, wherein an individual (e.g., employee) is assigned the responsibilities of multiple positions. For example, one drawback associated with the situation of having an employee perform more than one role within a business is that it leads to high employee dissatisfaction and turnover. This, in turn, results in workflow interruption and inefficiency when tasks and processes must be reassigned to another employee. Often times the turnover in employees can lead to tasks and processes being unattended and remaining uncompleted. This situation is frequently problematic for the success and prosperity of any growing organization.

Accordingly, it is desirable to provide a method and system that automatically addresses the above-mentioned difficulties of managing process-flow performance in a complex and widely situated organization, prone to increases in work-force size. It is further desirable to provide a method and system that identifies and tracks workflow and work processes so that they may be managed efficiently and through to completion. It is further desirable to provide a method and system that reduces the effect of disruption to workflow processes caused by individuals changing positions regularly, so as to maintain continuity of action and purpose in particular tasks at hand. It is further desirable to provide a method and system for tracking workflow in the manner that can be easily accessed and consistently distributed amongst the strata of members within an organization.

### SUMMARY OF THE INVENTION

The opportunity tracking information system present invention includes a method for managing tasks in a computer communication network. The method includes accessing a centralized database, containing information on tasks and their status. The status of each task includes, but is not limited to: a description of the task, and the person (or persons) within the organization responsible for completing the task. The program used to access the server is preferably a browser or other computer program designed for access across a network. After identifying the person using the program as the “user”, the status of all tasks associated with that user or individuals for whom the user has authority to monitor is displayed in a formatted manner. The user may then update the status of tasks that he is permitted to view. In general, a user may view the status of a task if the user is responsible for accomplishing the task or if the person responsible for accomplishing the task reports to the user within the organizational structure. Thus, the ability to view tasks parallels an organizational chart since a user at a position in the organizational chart can view tasks for that position and tasks for any position in the organizational chart below that position. Among the updates that the user may accomplish are creating new tasks for himself or for those who report to him, marking tasks as being finished, and assigning (moving) a task to other individuals or positions within the organization.

More specifically in an embodiment using the Internet, the method of the present invention includes the step of accessing a first server from at least one client program such as a browser. The first server accesses an online account to retrieve status information associated with the tasks stored on a database for display currently to the client browser. In response to receiving a user instruction for managing the tasks, updates of the status information are generated. The updated status information is provided from the server to the client browser for display thereon.

With the above method, the present invention is designed to track anomalies, routine automatic tasks, and manually inputted tasks by the positions of those individuals as defined within an organization. This hierarchical approach facilitates management and administration of projects. By providing a management tool that in one embodiment is implemented over a network, individuals may uniformly identify, track and manage the completion of tasks. Furthermore, administrators may implement the opportunity tracking information system of the present invention in a scalable manner that is useful to those organizations having a work force widely situated throughout multiple locations.

In one key aspect of the present invention, the opportunity tracking information system merges the organizational structure of an organization inherently into the processes for creating, editing, moving, adding, removing or viewing tasks. In particular, the opportunity tracking information system provides three general types of users: users, managers and administrators. A user refers to a position in the organization chart that does not have any nodes or positions below it. Thus, the system provides a user typically with only the ability to view tasks for a particular position or person; and can create, edit, add or remove tasks only for that position. A manager refers to a position in the organization chart that has at least one node or position below it. A manager has the same rights as a user but can also perform any of the actions on tasks for the nodes below (or reporting to) the manager position. The system therefore provides managers with the ability to view tasks for their position and any position below or reporting to their position; and the ability to create, edit, add or remove tasks their position and any position below or reporting to their position. An administrator refers to a position that is responsible for ensuring the system and the processes for tasks that the system allows match the organization chart of an organization. The administrator has the same rights as a user but can also modify control parameters for operation of the system. The administrators have the capability to change, which positions report to other positions, and thus, the tasks that each position may view, edit, modify or assign. It should be understood that a particular person could be both a manager and an administrator type and thus the system would allow that user to perform actions of either type. Accordingly ever user will be able to perform different actions and view different data depending the type of user they are.

Another aspect of the present invention includes a management tool that allows multiple views of what is to be done within an organization. Individuals are allowed to view information about the tasks to be accomplished, to update the status of the work items in an interactive manner and to enter new work items. The extent to which an individual may manipulate the attributes of a work item is controlled by the individual's class and position within an organization.

### BRIEF DESCRIPTION OF THE DRAWINGS

FIG. 1 is block diagram illustrating a first embodiment of the opportunity tracking information system for the automatic management of process flow performance in accordance with the present invention.

FIG. 2 is a flowchart that illustrates a process by which a user gains access to the system of FIG. 1 in accordance with the present invention.

FIG. 3 is a flowchart illustrating a method for determining whether a user has previously established a customized home page once the user has successfully logged into the system.

FIG. 4 is a flowchart illustrating a method of determining how status information (e.g., tasks and anomalies) is reviewed or edited.

FIG. 5 is a flowchart illustrating a method for providing status information concerning the administrative features in accordance with the present invention.

FIG. 6 illustrates an exemplary graphical representation of a user interface for allowing an individual to input the user identification number (User ID) and password.

FIG. 7 illustrates an exemplary graphical representation of a user interface having a default home page combined with the status information retrieved from the database.

FIG. 8 illustrates an exemplary graphical representation of a user interface enabling a user to describe in detail the anomaly and the anomaly type in accordance with the present invention.

FIG. 9 illustrates an exemplary graphical representation of a user interface enabling a manager to assign a priority level to the anomaly in accordance with the present invention.

FIG. 10 illustrates an exemplary graphical representation of a user interface enabling the completion and approval of an anomaly in accordance with the present invention.

FIG. 11 illustrates an exemplary graphical representation of a user interface (review screen) enabling a manager to review any anomaly.

FIG. 12 illustrates an exemplary graphical representation of a user interface enabling a user to review pending tasks and anomalies.

FIG. 13 illustrates an exemplary graphical representation of a user interface that allows the user to enter the information about a task.

FIG. 14 illustrates an exemplary graphical representation of a user interface enabling the input of information used to track the date that a task was inputted and the priority assigned thereto.

FIG. 15 illustrates an exemplary graphical representation of a user interface enabling a manager to assign the amount of time for a task to be completed in accordance with the present invention.

FIG. 16 illustrates an exemplary graphical representation of a user interface where managers are allowed to check when they want to receive email notification.

FIG. 17 illustrates an exemplary graphical representation of a user interface indicating the occurrence of a task on the input screen in accordance with the present invention.

FIG. 18 illustrates an exemplary graphical representation of a dialog box that allows the user to assign the occurrence of the task.

FIG. 19 illustrates an exemplary graphical representation of a user interface for reviewing tasks.

FIG. 20 illustrates an exemplary graphical representation of a user interface for escalating a task that remains incomplete.

FIG. 21 illustrates an exemplary graphical representation of a user interface that indicates position classes and positions in accordance with the present invention.

FIG. 22 illustrates an exemplary graphical representation of a user interface enabling a manager to review all the templates that exist for projects assigned thereto.

FIG. 23 illustrates an exemplary graphical representation of a user interface for reviewing status information according to the calendar option in accordance with the present invention.

FIG. 24 illustrates an exemplary graphical representation of a user interface for reviewing anomalies and tasks on a weekly basis.

FIG. 25 illustrates an exemplary graphical representation of a user interface enabling administrators to enter updates to the status information.

FIG. 26 illustrates an exemplary graphical representation of a user interface enabling disciplines to be assigned to a project.

FIG. 27 illustrates an exemplary graphical representation of a user interface for indicating project bugs in accordance with the present invention.

FIG. 28 illustrates an exemplary graphical representation of a user interface listing all of the anomaly types that are maintained and the new ones that are added in accordance with the present invention.

FIG. 29 is a block diagram of a first embodiment for the client computer.

FIG. 30 is a block diagram of the memory unit of FIG. 29.

FIG. 31 is a block diagram of an organizational chart with the class and position for different individuals as used by the system of the present invention.

FIG. 32 is a flowchart of one embodiment for the operation of the OTIS system demonstrating its integration of organizational structure with the work process flow.

### DETAILED DESCRIPTION OF THE EMBODIMENTS

A system and method for displaying, assigning, modifying, deleting, creating and tracking tasks in a computer system is described. In the following description, for purposes of explanation, numerous specific details are set forth in order to provide a thorough understanding of the invention. It will be apparent, however, to one skilled in the art that the invention can be practiced without these specific details. In other instances, structures and devices are shown in block diagram form in order to avoid obscuring the invention.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

Some portions of the detailed description that follows are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention also relates to an apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus. Furthermore, the computers referred to in the specification may include a single process or may be architectures employing multiple processor designs for increased computing capability.

The algorithms and displays presented herein are not inherently related to any particular computer or other apparatus. Various general-purpose systems may be used with programs in accordance with the teachings herein, or it may prove convenient to construct more specialized apparatus to perform the required method steps. The required structure for a variety of these systems will appear from the description below. In addition, the present invention is not described with reference to any particular programming language. It will be appreciated that a variety of programming languages may be used to implement the teachings of the invention as described herein, and any references below to specific languages are provided for disclosure of enablement and best mode of the present invention.

Moreover, the present invention is claimed below as operating on or working in conjunction with an information system. Such an information system as claimed may be the entire opportunity tracking information system as detailed below in the preferred embodiment or only portions of such a system. For example, the present invention can operate with an information system that need only be a browser in the simplest sense to present and display objects. Thus, the present invention is capable of operating with any information system from those with minimal functionality to those providing all the functionality disclosed herein.

Reference will now be made in detail to several described embodiments of the present invention, examples of which are illustrated in the accompanying drawings. Wherever practicable, the same reference numbers will be used throughout the drawings to refer to the same or like parts.

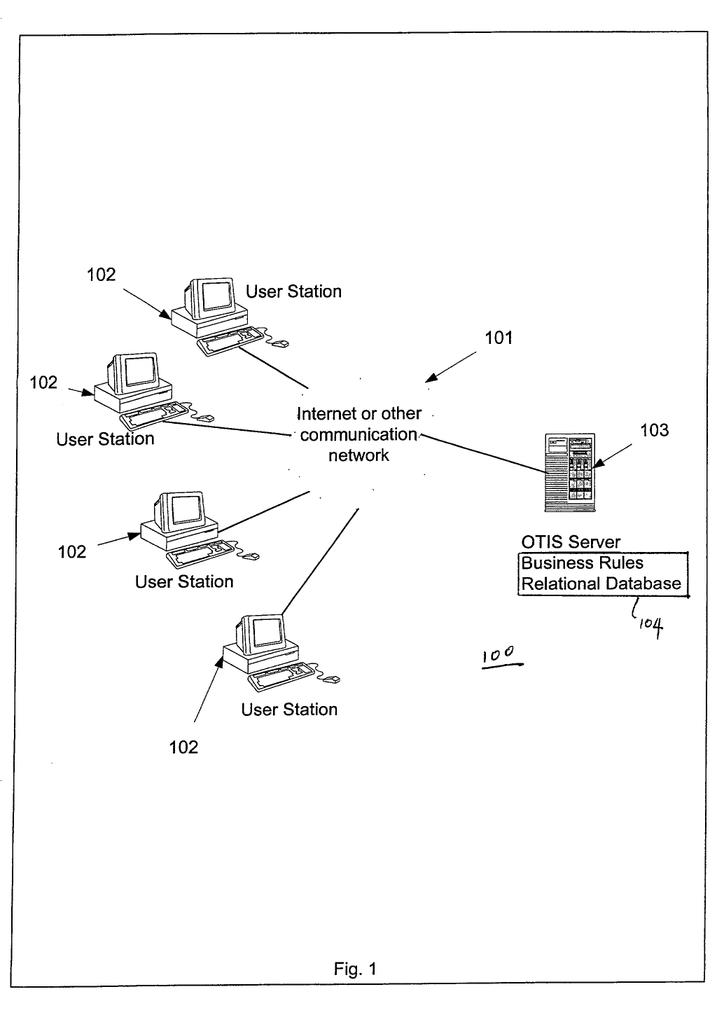

Referring now to FIG. 1, there is shown an example of a system 100 having a communication network 101 that implements the opportunity tracking information system (referenced interchangeably as “OTIS”) for the automatic management of process flow performance in accordance with the present invention. In the example of FIG. 1, one or more user stations 102 (used interchangeably herein with “client computers 102,” “workstations 102,” and “clients 102”) communicate over network 101 with at least one server computer 103 (used interchangeably with “server 103”). It will be appreciated by those skilled in the art that the number of clients 102 and servers 103 may vary based upon design or user requirements.

One embodiment of the network 101 in accordance with the present invention includes the Internet. However, it will be appreciated by those skilled in the art that the present invention works suitably well with a wide variety of computer networks over numerous topologies, so long as network 101 connects the distributed user stations 102 to server 103. For example, other public or private communication networks that can be used for network 101 include Local Area Networks (LANs), Wide Area Networks (WANs), intranets, virtual private networks (VPNs), and wireless networks (i.e., with the appropriate wireless interfaces as known in the industry substituted for hard-wired communication links). Generally, these types of communication networks can in turn be communicatively coupled to other networks comprising storage devices, server computers, databases, and client computers that are communicatively coupled to other computers and storage devices.

Each user works with system 100 to seamlessly access server 103 through a workstation 102 interfaced to network 101. Referring now to FIG. 29, a first embodiment for the client computer 102 is shown. The client computer 102 comprises a control unit 1350 coupled to a display device 1300, a keyboard 1322, a cursor controller 1323, a network controller 1324 and an I/O device 1325 by a bus 1301.

Control unit 1350 may comprise an arithmetic logic unit, a microprocessor, a general purpose computer, a personal digital assistant or some other information appliance equipped to provide electronic display signals to display device 1300. In one embodiment, control unit 1350 comprises a general purpose computer having a graphical user interface, which may be generated by, for example, a program written in Java running on top of an operating system like WINDOWS® or UNIX® based operating systems. In one embodiment, one or more application programs executed by control unit 1350 including, without limitation, word processing applications, electronic mail applications, spreadsheet applications, database applications and web browser applications generate the displays, store information, retrieve information as part of OTIS 100. The control unit 1350 also has other conventional connections to other systems such as a network for distribution of files (media objects) using standard network protocols such as TCP/IP, http, and SMTP as will be understood to those skilled in the art and shown in detail in FIG. 29.

As shown in FIG. 29, the control unit 1350 includes a processor 1302, main memory 1304, and data storage device 1307, all of which are communicatively coupled to system bus 1301.

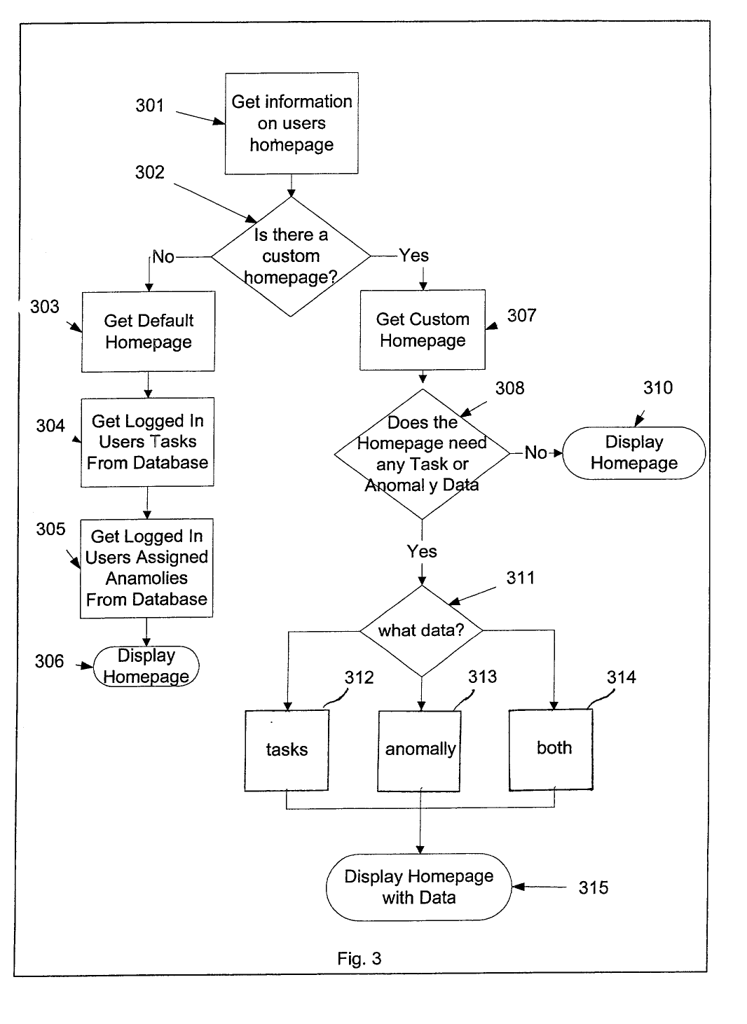

Processor 1302 processes data signals and may comprise various computing architectures including a complex instruction set computer (CISC) architecture, a reduced instruction set computer (RISC) architecture, or an architecture implementing a combination of instruction sets. Although only a single processor is shown in FIG. 3, multiple processors may be included.

Main memory 1304 may store instructions and/or data that may be executed by processor 1302. The instructions and/or data may comprise code for performing any and/or all of the techniques described herein. Main memory 1304 may be a dynamic random access memory (DRAM) device, a static random access memory (SRAM) device, or some other memory device known in the art. The memory 1304 preferably includes a web browser 1330 is of a conventional type that provides access to the Internet and processes HTML, XML or other mark up language to generated images on the display device 1300. For example, the web browser 1330 could be Netscape Navigator or Microsoft Internet Explorer. The main memory 1304 preferably also includes a client program as will be described in detail below to enable communication between the client computer 102 and the server 103 for creating, editing, moving, adding, removing or viewing tasks.

Data storage device 1307 stores data and instructions for processor 1302 and may comprise one or more devices including a hard disk drive, a floppy disk drive, a CD-ROM device, a DVD-ROM device, a DVD-RAM device, a DVD-RW device, a flash memory device, or some other mass storage device known in the art.

System bus 1301 represents a shared bus for communicating information and data throughout control unit 1350. System bus 1301 may represent one or more buses including an industry standard architecture (ISA) bus, a peripheral component interconnect (PCI) bus, a universal serial bus (USB), or some other bus known in the art to provide similar functionality.

Additional components coupled to control unit 1350 through system bus 1301 include display device 1300, keyboard 1322, cursor control device 1323, network controller 1324 and audio device 1325. Display device 1300 represents any device equipped to display electronic images and data as described herein. Display device 1300 may be a cathode ray tube (CRT), liquid crystal display (LCD), or any other similarly equipped display device, screen, or monitor.

Keyboard 1322 represents an alphanumeric input device coupled to control unit 1350 to communicate information and command selections to processor 1302. Cursor control 1323 represents a user input device equipped to communicate positional data as well as command selections to processor 1302. Cursor control 1323 may include a mouse, a trackball, a stylus, a pen, a touch screen, cursor direction keys, or other mechanisms to cause movement of a cursor. Network controller 1324 links control unit 1350 to a network that may include multiple processing systems. The network of processing systems may comprise a local area network (LAN), a wide area network (WAN) (e.g., the Internet), and/or any other interconnected data path across which multiple devices may communicate.

One or more I/0 devices 1325 are coupled to the system bus 1301. For example, the I/O device 1325 may be an audio device equipped to receive audio input and transmit audio output. Audio input may be received through various devices including a microphone within audio device 1325 and network controller 1324. Similarly, audio output may originate from various devices including processor 1302 and network controller 1324. In one embodiment, audio device 1325 is a general purpose; audio add-in/expansion card designed for use within a general purpose computer system. Optionally, audio device 1325 may contain one or more analog-to-digital or digital-to-analog converters, and/or one or more digital signal processors to facilitate audio processing.

It should be apparent to one skilled in the art that control unit 1350 may include more or less components than those shown in FIG. 29 without departing from the spirit and scope of the present invention. For example, control unit 1350 may include additional memory, such as, for example, a first or second level cache, or one or more application specific integrated circuits (ASICs). Similarly, additional components may be coupled to control unit 1350 including, for example, image scanning devices, digital still or video cameras, or other devices that may or may not be equipped to capture and/or download electronic data to control unit 1350.

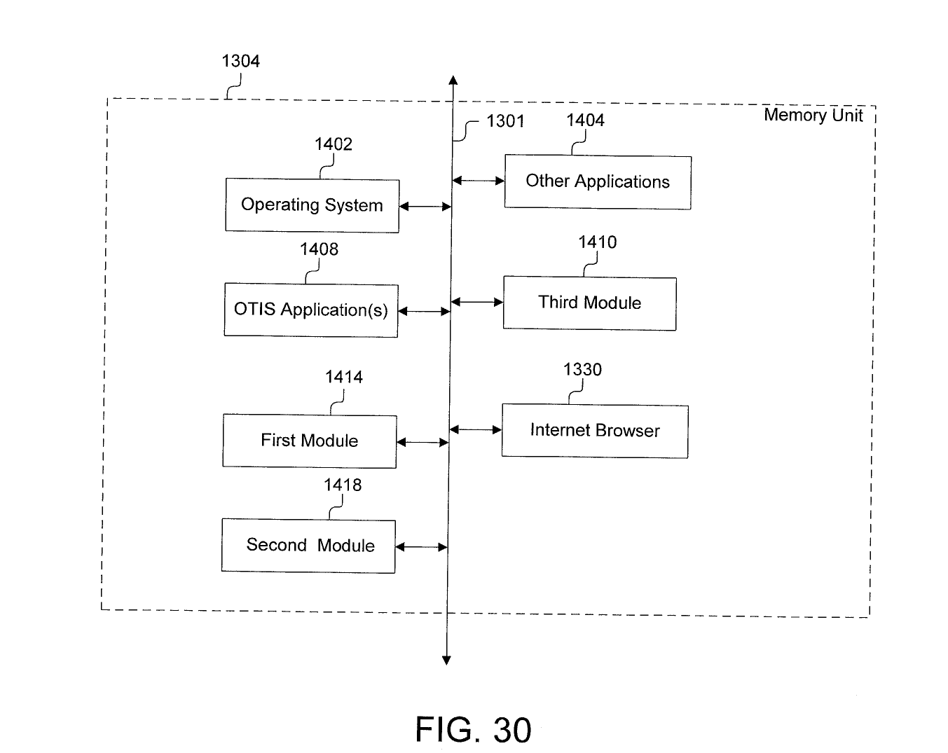

Referring now to FIGS. 29 and 30, the server 103 will be described in more detail. The server 103 preferably includes a control unit 1350 coupled to a display device 1300, a keyboard 1322, a cursor controller 1323, a network controller 1324 and an I/O device 1325 by a bus 1301. As shown in FIG. 29, the control unit 1350 includes a processor 1302, main memory 1304, and data storage device 1307, all of which are communicatively coupled to system bus 1301. For convenience and ease of understanding like reference numerals have been used for similar components used in both the client computer 102 and the server 103. In the preferred embodiment, the server 103 is a multiple processor system such as a Dell 1800 made and sold by the Dell Computer Corporation, and the data storage device 1307 stores a database.

In accordance with the present invention, OTIS 100 uses network 101 as a backbone to allow component parts of an organization to communicate with database 104 and each other. As shown in the example of FIG. 1, server 103 incorporates database 104 therein (i.e., locally), although other configurations of the database 104 and server 103 are well suited to work with the present invention. For example, multiple remote databases can be communicatively coupled to server 103 and throughout network 101.

Network 101 enables the communication between multiple components of server 103 and other devices, which may or may not be co-located, but may be distributed for convenience, security or other reasons. To facilitate the communication between clients 102 and server 103, a client-server computer network operating system (NOS), which is an operating system used to manage network resources, is used in conjunction with the present invention. NOS can manage multiple inputs or requests concurrently and may provide the security necessary in a multi-user environment. An example of NOS includes Windows NT manufactured by the Microsoft Corporation of Redmond, Wash. Other operating systems that are applicable include Windows 2000, Unix, Sun Microsystems' Solaris, and Novell Netware.

Client 102 and server 103 of system 100 may beneficially utilize the present invention, and may contain an embodiment of the process steps and modules of the present invention in the form of a computer program. Alternatively, the process steps and modules of the present invention could be embodied in firmware or hardware, and when embodied in software, could be downloaded to reside on and be operated from different platforms used by real time network operating systems.

Referring now to FIG. 30, the memory unit 1304 is shown in more detail. In particular, the portions of the memory 1304 needed for the processes of the present invention are shown and will now be described more specifically. As shown in FIG. 30, the memory unit 1304 preferably comprises an operating system 1402, other applications 1404, at least one OTIS application 1408, a first module 1414, a second module 1418, a third module 1410 an a internet browser 1330. As noted above, the memory unit 1304 stores instructions and/or data that may be executed by processing unit 1302. The instructions and/or data may comprise code for performing any and/or all of the techniques described herein. These modules 1402-418 are coupled by bus 1301 to the processing unit 1302 for communication and cooperation to provide the functionality of the system 100. Those skilled in the art will recognize that while the present invention will now be described as modules or portions of the memory unit 1304 of a computer system, the modules or portions may also be stored in other media such as permanent data storage and may be distributed across a network having a plurality of different computers such as in a client/server environment.

The operating system 1402 is preferably one of a conventional type such as, WINDOWS®, SOLARIS® or LINUX® based operating systems.

The memory unit 1304 may also include one or more other application programs 1404 including, without limitation, word processing applications, electronic mail applications, and spreadsheet applications.

The OTIS application 1408 is a procedure or routines that control the processor 1302. Although only a single OTIS application 1408 is shown in the memory 1304 of FIG. 30 for ease of understanding the present invention, the server 103 will typically have several such OTIS applications 1408; each application used for displaying information for a particular organization. The OTIS application typically includes three layers of software according to the present invention. These three layers are described below as the first, second and third modules 1414, 1418 and 1410.

The Internet browser 1330 is of a conventional type and shown here for consistency with FIG. 29.

In one embodiment, the system 100 of the present invention includes a first module 1414, a second module 1418 and a third module 1410. The first module 1414 is a program for controlling the server 103 and its components to enable communication across the network 101 with the client computers 102. The second module 1418 is a plurality of business objects that interact with each other and the first and third modules 1414, 1410 to implement processes for the functionality of creating, editing, moving, adding, removing or viewing tasks consistent with the privileges assigned by position and user type. The third module 1410 controls the communication between the second module 1418 and the database 104. The third module 1410 includes processes for storing data in and retrieving data from the database 104 as well as communication with the second module 1418. Exemplary functions and implementation for the first, second and third module 1414, 1418, 1410 are described in more detail below.

A particular embodiment, provided only by way of example, implements the system 100 as a three-module or three-tier Intranet application implemented with the Microsoft Development Environment. The three modules or tiers 1414, 1418, 1410 include: (1) a first module 1414 or front-end tier having server 103 embodied as an Internet Information Server (IIS); (2) a second module 1418 or middle tier comprising Component Object Model (COM) objects; and (3) third module 1410 or backend database tier (e.g., SQL). Those skilled in the art will recognize that these particulars are provided only by way of example, and that a variety of other implementations with other types software are within the scope of the present invention.

Under the control of the first module, the server 103 communicates with the client computer 102. For example, the first module may be an IIS, which is the software module component of ActiveX that operates in a runtime environment enabling Active Server Pages (ASPs) to interface therewith. ASPs generally provide a framework for constructing Web applications using HTML, scripts and ActiveX components. The ASP page is created by embedding such scripts within the HTML page. As a user makes the request for an ASP page, the server 103 executes the scripts that have been embedded within the page so that the output generated from the running the scripts is included in the HTML, thus allowing a client browser on client 102 to view the page. It is noted that the present invention is well suited to work with other formats for creating forms and processing input, including Dynamic HTML (DHTML) technology. It will be evident to those skilled in the art that the client 102 is adapted to run various types of commercially available browsers (e.g., Netscape, Internet Explorer) suited to enable DHTML functionality. Furthermore, here and throughout this application, the description of the present invention in the context of the Internet, browsers, ASP, etc is only by way of example. Those skilled in the art will realize that the present invention could be implemented on a variety of other hardware environments such as peer-to-peer networks and mainframe systems just by way of example.

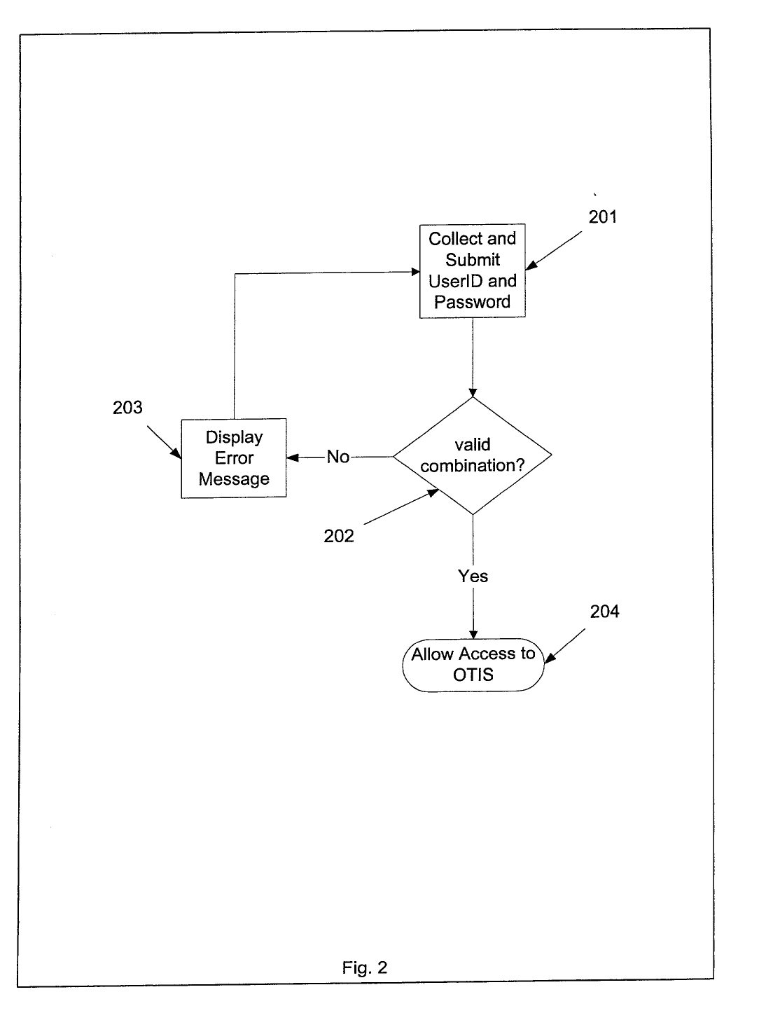

The second module or middle tier includes software to implement the business rules and data access functionality corresponding to the organizational chart of the entity. The second module is preferably implemented or encapsulated within one or more Component Object Model (COM) objects. The COM objects are a way for software components to communicate with each other. The COM objects are a binary and network standard that allows any two components to communicate regardless of what machine they're running on (as long as the machines are connected), what operating systems the machines are running (as long as it supports COM), and what language the components are written in. COM objects further provides location transparency: it doesn't matter to you when you write your components whether the other components are in-process DLLs, local EXEs, or components located on some other machine. The present invention preferably uses COM objects to enforce rules about transactions. For example, if a business rule is that you want no addresses in your database that do not have valid zip codes then calling a COM object to validate the address may be used. In this case it might check that the zip code was valid for the city and state specified. Using a COM object allows many applications to share the same code. A COM object might be used to validate the due date for a task e.g. to verify that it is in the future and that it falls on a workday rather than a weekend or a holiday. The COM object might also check that the due date does not fall on scheduled vacation day for the user to whom it is assigned. The present invention includes a variety of COM objects to implement the functionality described below with reference to the process flowcharts and screen shots of FIGS. 2-28. The versatility of this approach lies in the coding of COM components, and the referencing of the COM components from within the ASP pages. Such COM object can reside on the server 103 used to serve up the objects. In the preferred embodiment, the second module 1418 or middle tier layer of OTIS 100 is used to enforce a variety of business rules. For example, the second module 1418 enforces access rights and viewing privileges. For users, the second module 1418 or middle tier restricts the display of tasks to only those tasks assigned to a particular user. For managers, the second module 1418 or middle tier restricts the display and performance of other operations on tasks to the tasks for the manager and those users assigned to report to the manager. Finally, the second module 1418 or middle tier allow an administrator to establish roles, disciplines and projects to which a user or position is assigned. When a task is assigned to a position within the organization middle tier objects assure that only individuals assigned to that position can access it. A final example of middle tier object functionality within OTIS 100 is the use of COM objects to report exceptions within OTIS 100. This reporting may be as simple as changing the status of a task that is past due or more complex such as sending an email at the time a task falls more than a predetermined time behind schedule. Again, while the present invention is described in the context of COM objects, it is only by way of example. Those skilled in the art will realize that the present invention could be implemented using other software constructs, code and methods.

The third module 1410 or backend tier facilitates communication between server 103 and database 104. In this described embodiment, database 104 is preferably a relational database accessed with Structured Query Language (SQL). It is noted though, that the present invention is SQL independent; accordingly, those of ordinary skill in the art will recognize that there is no specific requirement that a SQL database must be utilized. The functionality of database 104 in accordance with the present invention is now discussed. In general, database 104 defines the details of the operation of system 100, and stores the information that is used in accordance with the present invention. In particular and as will be described in greater detail later, database 104 includes status information which defines a task (e.g., work item), associated attributes according to certain business rules, and the organizational structure of a business using the present invention.

### OTIS Login

Those skilled in the art should recognize that the present invention will now be described with reference to FIGS. 2-28, and while described in the context of a client-server interaction across the Internet with the particulars of such communication, the present invention is applicable to other contexts of communications between multiple users such as users of a main frame computer, users of other proprietary network systems, and the description here of the present invention in this specific context is only by way of example. It should be understood that the processes and methods of the present invention are applicable to any database being accessed by multiple users.

The operation of system 100 in accordance with the present invention is described below, starting with reference being made to the flowchart of FIG. 2, which illustrates a method by which a user gains access to OTIS. Once system 100 is running, the client 102 prompts the user for information to verify and authenticate the identification of the user.

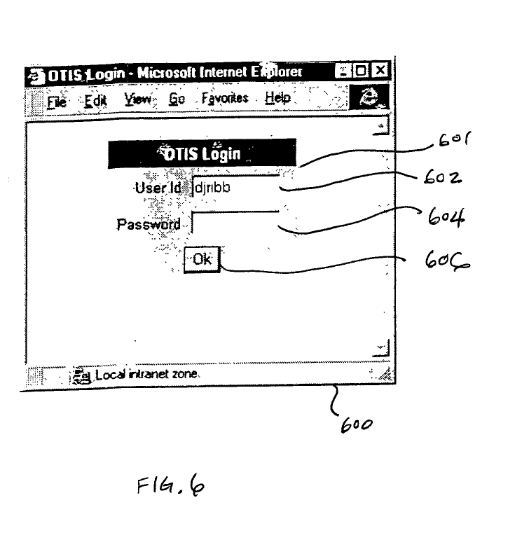

One aspect of the present invention includes a security system that restricts access to the system 100. With the security system, each user is associated with a user name (e.g., User ID) and password to login, access and use the OTIS system 100. The login also creates a user session, which will be discussed later in detail with respect to the level of access a user is given in the nature of defined rights that can restrict the user's access to certain areas of the system 100. For example, FIG. 6 shows one embodiment of a user interface (e.g., login screen) 600 allowing the user to input the User ID 602 and password 604. It is noted that user interface 600 includes a form 601, which is presented to the user at the client 102. Once that information is input and submitted 201 (e.g., the user clicks on the OK button 606), the client browser sends an instruction (e.g., HTTP request), including the User Id and password entered, to server 103. In response to the HTTP request being received by server 103, a session is invoked on server 103. As part of the session, the User ID 602 and password 604 are extracted from the HTTP request and compared 202 with a list of already established User Ids and passwords stored on the database 104. If the combination of input information is valid, then access to OTIS 100 is allowed 204 because the user information has been authenticated. However, if the combination is invalid (i.e., NO branch of 202), then an error message is 203 sent back from server 103 for display on client 102, after which the original login screen 600 is re-displayed.

### OTIS Home Page

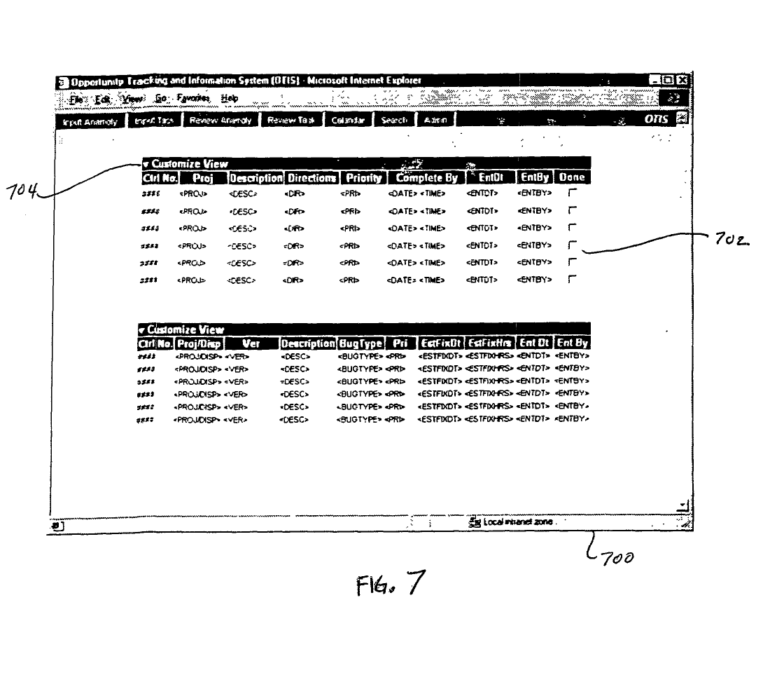

Reference is made to the flowchart of FIG. 3 to describe the process of determining whether a user has previously established a customized a display format or home page once the user has successfully logged into OTIS 100. A home page is the user's view of the data (i.e., the status information, which will be described subsequently in detail) in the system 100. Server 103 invokes a process to obtain 301 a home page for the user. To make this determination 302, server 103 accesses the database 104 to inquire about and retrieve the customized home page associated with the state values (e.g., cookie values) received in the request of for information (HTTP commands). If the user has not previously customized a home page (e.g., NO branch of 302), then a default home page is retrieved 303. The default home page is essentially a template with which status information can be incorporated. Next in step 304, using the state values (e.g., cookie values) that identify the user, the server 103 queries the database 104 to locate and retrieve previously saved status information (e.g., tasks assigned, anomalies). The status information is then incorporated with the default home page (e.g., in DHTML form) and transmitted from server 103 for display 306 on client 102. For example, FIG. 7 illustrates one embodiment of a user interface having a default home page 700 combined with the status information 702 retrieved from database 104. If status information was not found on the database 104 for the particular user, then the default home page is displayed 306 without data.

Still referring to FIG. 3, in step 302, if the user has a customized home page, then server 103 retrieves it from database 104 as indicated in step 307. Thereafter, a determination is made 308 as to whether the home page should be incorporated with status information. For example, server 103 uses the state information from the client 102 (e.g., cookie values) to locate (“personalized”) status information saved on database 104 that pertains to the user. If the personalized data does not exist, then the customized home page is formatted (e.g., DHTML) and transmitted from server 103 to client 102 for display 310. However, if personalized status information does exist in step 308 (i.e., YES branch), then server 103 invokes a query on the database 104 to determine 311 the type of personalized status information to retrieve. The type of information to be retrieved from database 104 can be, for example, tasks 312, anomalies 313, or a combination 314 of tasks and anomalies. The personalized status information retrieved is then incorporated with the customized home page (e.g., in DHTML form) and transmitted from server 103 for display 315 on client 102.

Referring back to FIG. 7, once the user gains access to OTIS 100, the home page 700 can be customized with user preferred settings. In order to personalize the home page 700, the user clicks on the top bar 704 of the table referenced as “Customize View.” This in turn presents to the user the option to view the current table, to change the sort order or to change the number of hours ahead that the table indicates. Once the user is finished customizing the views, the user preferences are stored by server 103 in database 104 using the state information (cookies) associated with the user logged into the user session. This aspect of the present invention pertaining to saving a customized home page enables users the ability to return to the previous settings associated with the former login session.

### The Operation of OTIS

### A. Definition of Terms

Before discussing the architectural design, requirements, business rules and development environment of the present invention, several definitions are introduced to clarify s the terms used herein. A task is defined to mean any work item that pertains to anything that requires attention. That is, a task is a work item that needs to be accomplished. An anomaly is defined to mean any development error in a project requiring attention. A position is defined to mean a person of the organization using their title as their reference (e.g., a developer). A position class is defined to mean a group of positions.

### B. General Overview and Classification of Individuals Using OTIS

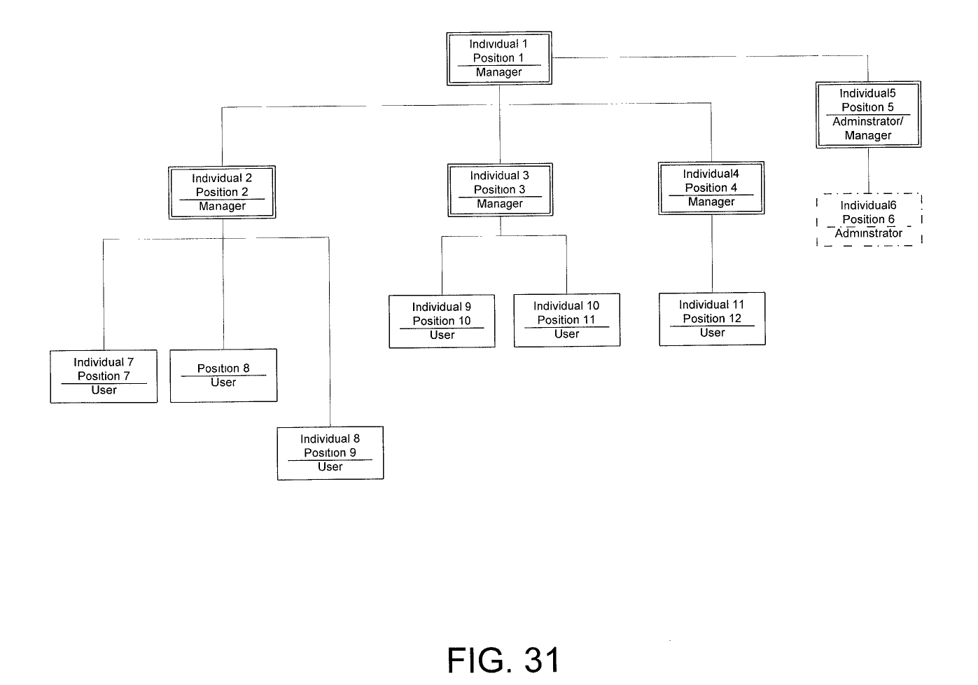

One aspect of the present invention includes a management tool that allows multiple views of what is to be done within an organization. That is, OTIS 100 allows individuals to view information about: the tasks to be accomplished and the anomalies to be rectified. Additionally, OTIS 100 allows individuals to update the status of the work items and anomalies, and to enter new work items and anomalies. The individual's class and position on the organization chart dictate the extent to which an individual may manipulate the attributes of a work item. Such an exemplary organizational chart with the class and position for different individuals in the organization is shown in FIG. 31.

Access to certain functions and features of the present invention require certain rights afforded to individuals using OTIS 100. Such rights are based upon a classification of the type of individuals using OTIS 100. In general, classes include users who have basic rights; managers who have the rights to assign tasks to people who report to them in the organization chart; and administrators who can modify control parameters in the system 100. One type of individual is a user, and a user is defined to mean any individual accessing and using OTIS 100. For example, within a business, a user is typically an employee. Referring to FIG. 31, positions 7-12 in the organizational chart are users. A manager is another type of individual, and is defined to be a supervisor of the organization, which may be a company, business, institution, or non-profit entity. Managers using OTIS are provided the right to maintain and assign (or reassign) tasks to be completed by individuals (e.g., users) whom they supervise within an organization infrastructure. Referring to FIG. 31, positions 1-5 in the organizational chart are managers. It will be apparent that managers (e.g., positions 2-5) in turn can be supervised by higher-level managers (e.g., position 1). Another type of individual is the administrator, which is defined to mean those having the responsibility to implement and maintain the organization or site. The rights of administrators allow them complete access to all functions and features of OTIS 100 (e.g., to do anything in the system). Referring to FIG. 31, positions 5 and 6 in the organizational chart are administrators. In one embodiment, these rights afforded based on the classification of the individual using OTIS 100 can be implemented by a “system administrator” of OTIS 100.

OTIS includes the management structure of the organization within database 104. For example, the “organization chart” is entered interactively, using standard industry practices such as “drag and drop” to allow the modification of the organization chart which is represented graphically. Lines of authority and responsibility are indicated in this database 104.

OTIS is designed to track anomalies, routine automatic tasks, and manually inputted tasks by the positions of those individuals as defined within an organization. OTIS stores the status information about work items to be accomplished in the database 104. Work items have multiple attributes associated with them. The attributes include, but are not limited to, description, required completion date, priority, duration, originator and assignee. The attributes are entered into the system interactively via the communication network 101. There are a variety of ways to organize the tasks. For example, work-items can be grouped by projects. To associate a project with a work item, each work item is uniquely identified by a serial number assigned to it at the time it is created, and generally, this number may not be changed. The changing or setting of the attributes is controlled so that only authorized individuals may create and/or modify them. Work items may occur only once or may be repetitive.

Once a work-item has been created it must be assigned to a responsible individual (or group of individuals). The assignment may only be made by an individual's manager. OTIS tracks the due date and completion of each item. It allows users to enter the fact that they have completed tasks or anomalies, and managers to verify the completion of the tasks or anomalies. Tasks that are not completed on time may be reported to the manager of the assignee as determined by the organization chart. The time delay between the failure to complete and the notification is a system parameter. The action of notifying higher levels of management is termed escalation. Management at even higher levels may also be notified at the same time or after a further delay. The notification takes place over the communication network.

OTIS allows all classes of individuals to view the state of work-items within the system. Each user may customize how they view the work items. All users may control which items they see. They may be selected by status and sorted by multiple criteria. The ability to see an item at all is controlled by project; users are assigned to projects and may only view items on that project. Additionally, items may be made visible or invisible to outside auditors (for example customers) who may view selected items in their projects.

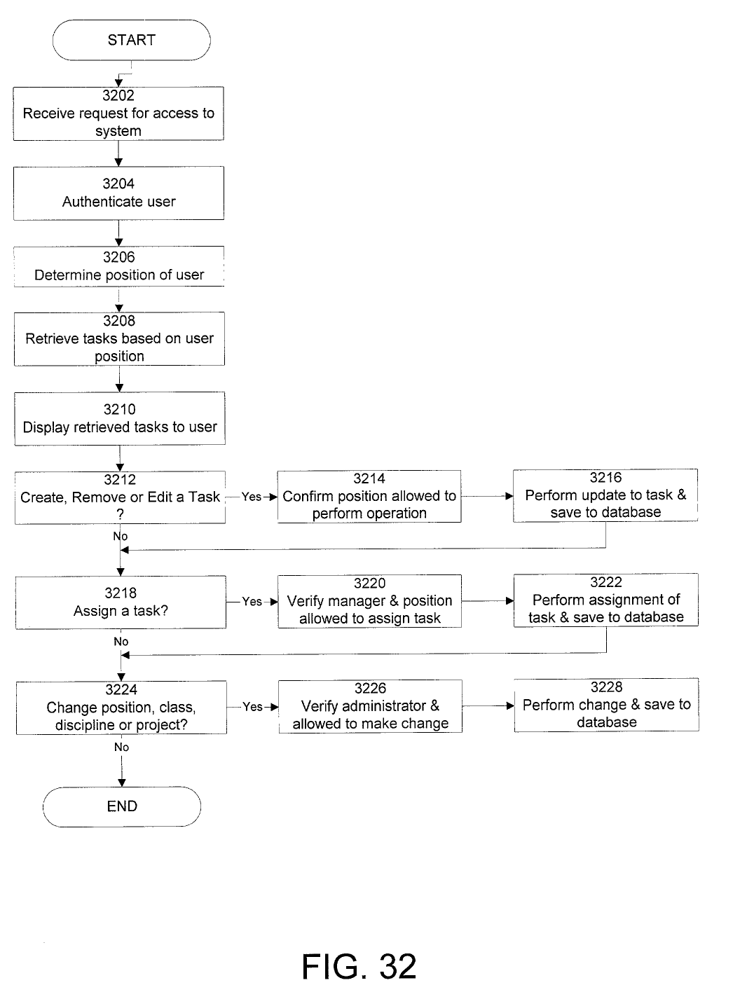

The functionality described above is integrated into a system 100 that automatically uses position and class to determine what operations a user is able to perform. An exemplary method for operation of the invention is shown in FIG. 32. The process begins by receiving 3202 a request for access to the system 100, and authentication 3204 of the user. Then based on the input user information, the position of the user is determined 3206. The position of the user determines whether they are a user, manager, or administrator, and what other users or positions report to them. Then the tasks associated with the determined position are retrieved 3210. This could include task of other positions that report to the determined position in the organizational chart. Next, the process determines 3212 whether the user can create, remove or edit a task. If so the method confirms 3214 that the position is allowed to perform the operation before performing the operation 3216 on the task and saving the updated data to the database. After either step 3212 or step 3216, the method determines 3218 whether the user is assigning a task. If so the method verifies 3220 that the position is a manger and that the position is allowed to perform the operation before assigning 3222 the task and saving the updated data to the database. After either step 3218 or step 3222, the method determines 3224 whether the user is attempting to change a position, class, project membership or some other administrative operation. If so the method verifies 3226 that the position is an administrator and that the position is allowed to perform the operation before executing the operation 3228 on the task and saving the updated data to the database. After either step 3224 or step 3228 the process is complete and ends. As can be seen from this process, the modifications to the process flow are high and seamlessly integrated into positions in the organizational chart.

### C. Anomaly Overview

One aspect of the present invention is to assist supervisors with tracking the progress of a project. One example for doing so is with the present invention tracking anomalies. With all of the anomalies listed in one central location, it is easier for the developer as well as the supervisor to review the project status because the outstanding issues, i.e., development error in a project requiring attention, can be immediately discerned and focused upon. One aspect of the security feature in OTIS 100 enables the developers to “see” only the project(s) they are assigned to.

One technical advantage of the present invention is that anomalies are designed to track the problems associated with any kind (i.e., subject matter) of project. Once a user accesses OTIS 100, the user can enter, review, and edit an anomaly subject to those rights afforded by the administrator, which for example may be on a project-by-project basis.

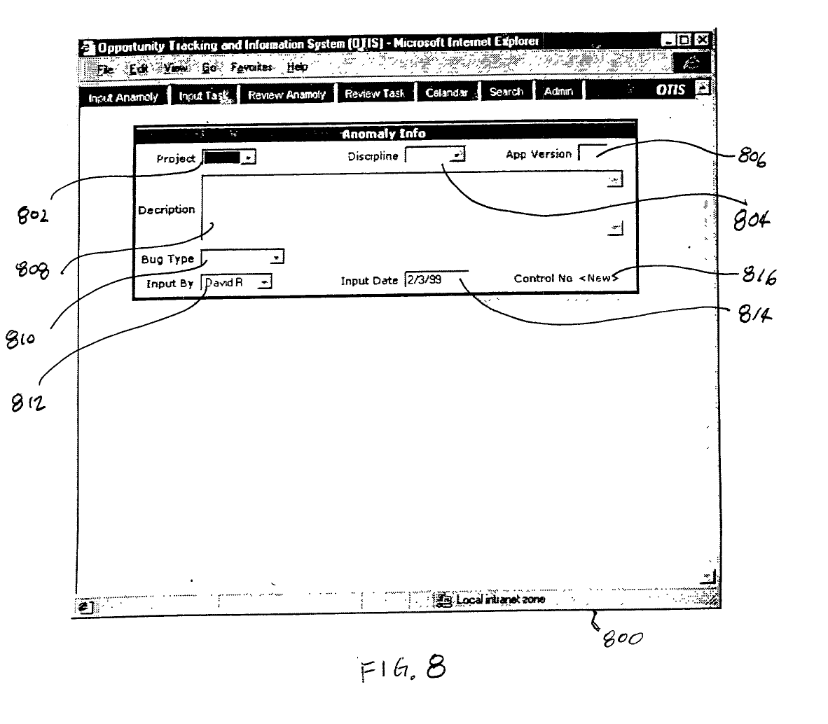

Reference is made to FIG. 8, which illustrates an example of a user interface 800 enabling a user to describe in detail the anomaly and the anomaly type. In general, an individual with the user right can view this interface to supply input status information to the data input screen, that is, to assign and define the anomaly for a project. In one embodiment in accordance with the present invention, identifying information can be input to describe the anomaly as follows. For example, a project indicator 802 identifies the project that has the anomaly, and the user can select the particular project from a list of projects that the user has been assigned to. A discipline indicator 804 identifies the corresponding discipline that applies to the selected project. An application (App) version indicator 806 designates the version of the current application. A description field 808 allows the user to enter a detailed description of the anomaly. Using a bug type field 810, the user can indicate a particular bug associated with the anomaly by selecting such from a predefined list. The user inputting the information about the anomaly can be identified by the Input By field 812. An Input Date field 814 allows the user to indicate the date and the time in which the anomaly was input. A control number field 816 indicates an individual number assigned to the anomaly for tracking purposes, and preferably should not be changed.

One advantage of having the above-information inputted is to let the project developer know what needs to be fixed or finished and by what time. The task part of OTIS 100 will allow supervisors to assign reoccurring tasks to a position (individual). If the individual assigned is unavailable, another person may be substituted and by reviewing this information, will know all of the daily tasks that need to be completed.

### D. Assignment Information

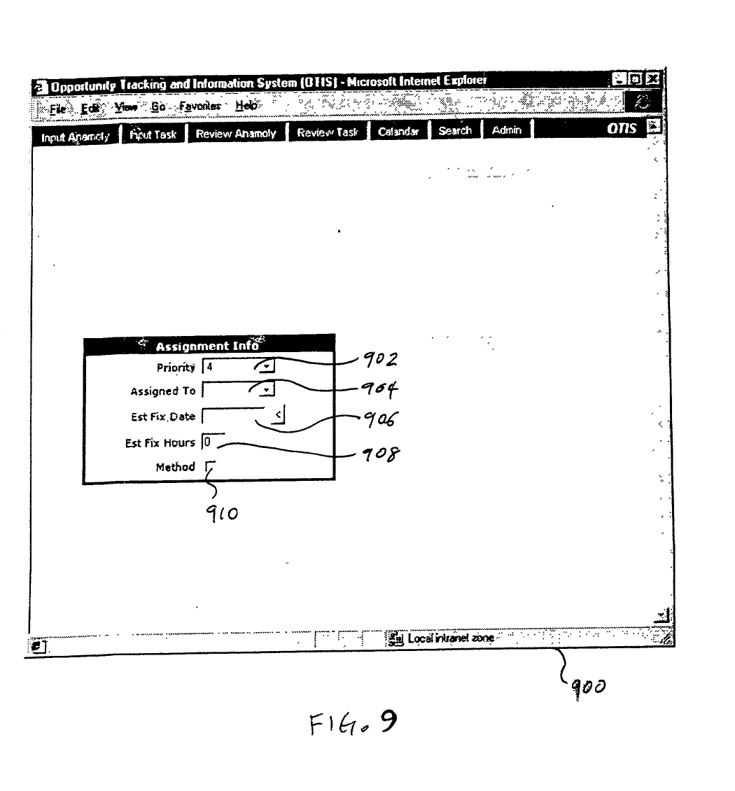

Another aspect of the present invention gives managers the ability to assign an individual (i.e., typically a user, but sometimes another manager, usually a subordinate) the task of fixing the anomaly. Reference is made to FIG. 9 to illustrate an example of a user interface 900 enabling a manager to assign a priority level 902 to the anomaly. The priority level indicates the urgency of having the anomaly rectified, and provides an indication of which anomalies should be given immediate attention to as opposed to those anomalies that can be addressed subsequently. For example, a priority of 1 through 9 can be assigned in field 902, where 1 represents the highest priority and 9 represents the lowest priority. With the Assigned To field 904, the manager can designate the individual who will assume responsibility for rectifying the anomaly. A drop-down menu is provided to facilitate the selection of the individual assigned the task, however, the individual generally should have been previously assigned rights to work on the particular project. The manager can also indicate a date in field 906 for which the anomaly is estimated to be fixed by, as well as an estimate of the number of hours in field 908 to resolve the anomaly. In field 910, the manager indicates a method, which represents whether the customer is permitted to see the anomaly or not.

### E. Fixed Information

In response to being assigned a task and completing the task, including rectifying an anomaly, users can provide notification to OTIS 100 of the completion of the task. Generally, individuals having user rights can only mark off their work items, while by comparison; managers can edit all entries with information pertaining to the completion of a task.

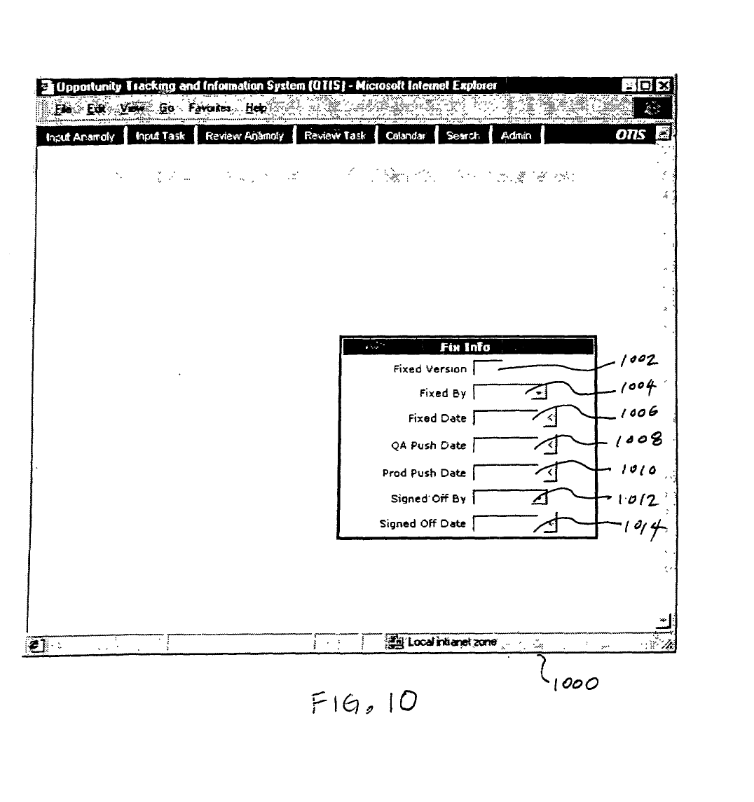

For example, reference is made to FIG. 10 to illustrate an example of a user interface 1000 enabling: (1) a user assigned to fix an anomaly the ability to mark off the fact that the anomaly has been fixed; and (2) a manager the ability to complete the process by approving (e.g., completely signing off) the completion of the anomaly. In the example shown, the new version number of the project can be entered in the field entitled Fixed Version 1002. The individual resolving the anomaly for the project can be identified in the Fixed By field 1004. In the field labeled Fixed Date 1006, the individual enters the date on which the anomaly was fixed. These entries for these described fields in general should be filled in by users.

Still referring to FIG. 10, for the following fields, it is preferable that managers be given access to enter data. The QA Push Date field 1008 indicates date for which the new version of the project was moved to Quality Assurance (QA) or to Production. The Prod Push Date field 1010 indicates the date that the new version of the project was pushed to the production system. The Signed Off By field 1012 indicates the identity of the manager who signed off that the anomaly has been fixed. A drop-down menu can be provided to list such managers having the authority to approve the completion of the particular project. The Signed Off Date field 1014 indicates the date that the manager signed off the completion of the anomaly.

Users, managers and administrators generally receive information and interact with OTIS 100 in several ways. One manner in accordance with the present invention comprises interactively receiving information and interacting with OTIS 100 via a web browser running on the workstation (i.e., client 102). The browser displays forms on the workstation presenting information from OTIS 100 and allows, where appropriate, for the user to enter information into the system 100. The data that can be reviewed at the client 102 is dependent upon the privileges and position of the user within the organization.

A second manner in accordance with the present invention comprises individuals obtaining information from the system 100 by electronic mail. Parts of OTIS 100 allow for email notification, wherein email messages can be formatted and sent based on the content of database 104. For example, email messages can be sent to users to inform them of work items that are scheduled to be accomplished. Further, email messages can be sent to inform managers of work-items that have not been accomplished on schedule (i.e., in a timely manner). The parameters associated with these communications are preferably stored in database 104

### F. Screen Capture

Generally, individuals with any type of right (e.g., users, managers, administrators) can view and use the screen capture feature. For example, a user can capture the error being viewed on screen by inputting a command such as ALT+PrintScreen at client 102. The user can then navigate to the input screen to save the image. For example, a “Get Image” button can be provided, which upon invocation takes the screen capture from the clipboard and through an email module (e.g., NetTransport™) sends the image to the third module were it is stored in the database 104. This helps in finding the exact error. In an alternative embodiment, an individual can attach a file or multiple files to the anomaly and store it in the database 104. In an alternate embodiment, a button that brings up a help screen to guide the user through these steps can also be provided.

### G. Reviewing Anomalies

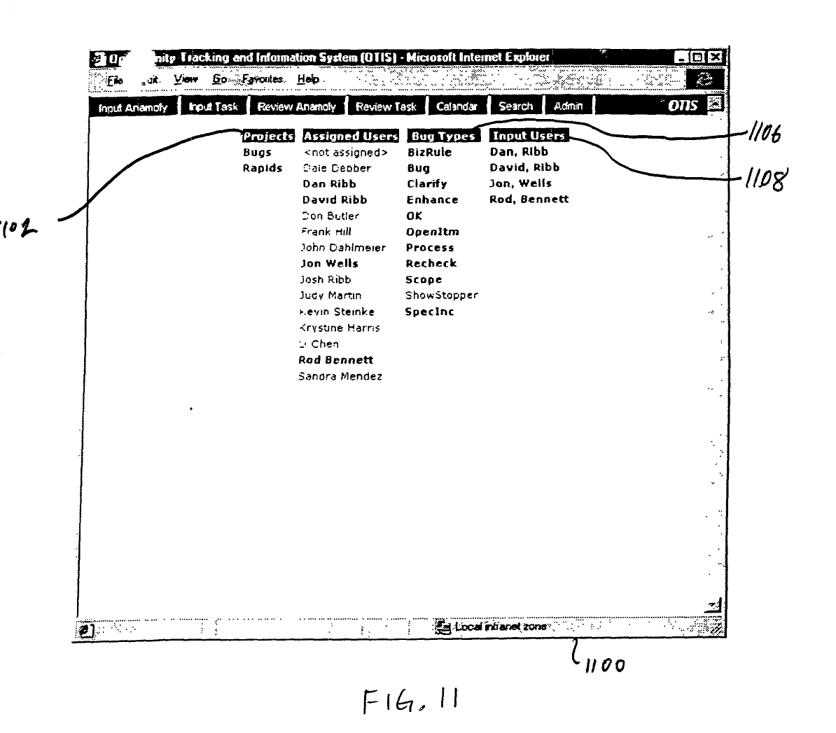

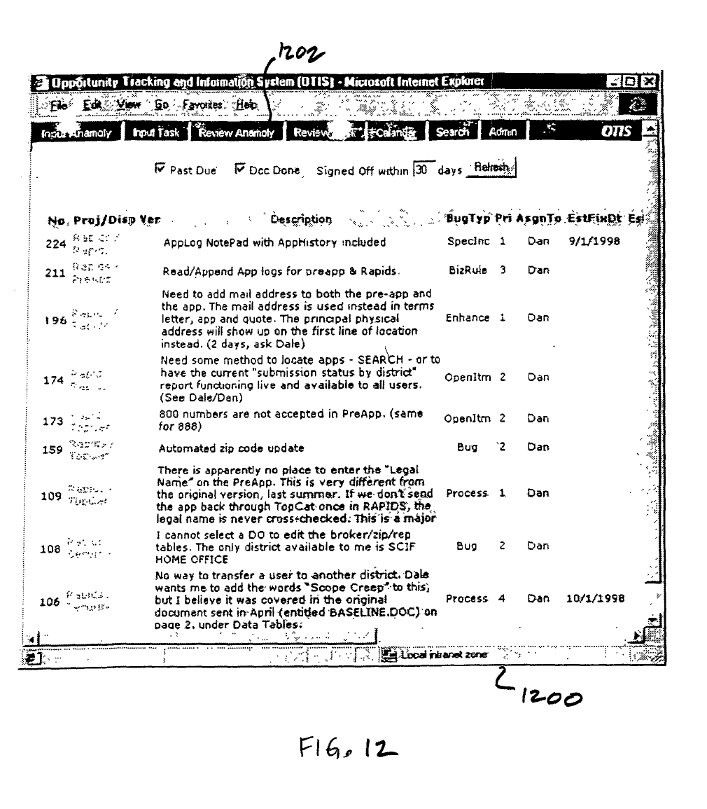

In one aspect of the present invention, managers can view any anomaly through a novel display format. Referring to FIG. 11, an illustration is shown of an example of a user interface 1100 (review screen) for displaying to a manager for review any anomaly. In the example shown, the review screen illustrates that the anomalies can be viewed in a tabular format of row and columns similar to a spreadsheet. Additionally, the priority assigned to an anomaly determines what color the row is so the individual (e.g., manager) may quickly see the priority of the anomalies. The anomalies can be listed by the project 1102 they are assigned to, a user specified or unassigned 1 104, bug types 1106 and input users 1108. By contrast, those users who may view anomalies are generally assigned to the particular project associated with the anomaly. For example, a user can review the pending tasks and anomalies as shown in FIG. 12. It is noted that a manager would see more details of a task and anomaly, similar to the details shown in FIG. 12, by clicking upon one of the entries in FIG. 11.

Whichever level of access an individual (i.e., user v. manager) has to review the list of anomalies, the individual can sort entries by a variety of parameters. For example, such parameters include the control number, project name, version, bug type, priority, assigned to estimated fix date, signed off date, and input user. Individuals can also “turn off” rows that contain signed off data, past due tasks, and anomalies that are not done. They may also click on the control number to take them back to the input screen to edit the anomaly. It is preferable though, that no user, except the original inputting user, is allowed to edit the text in the assignment information.

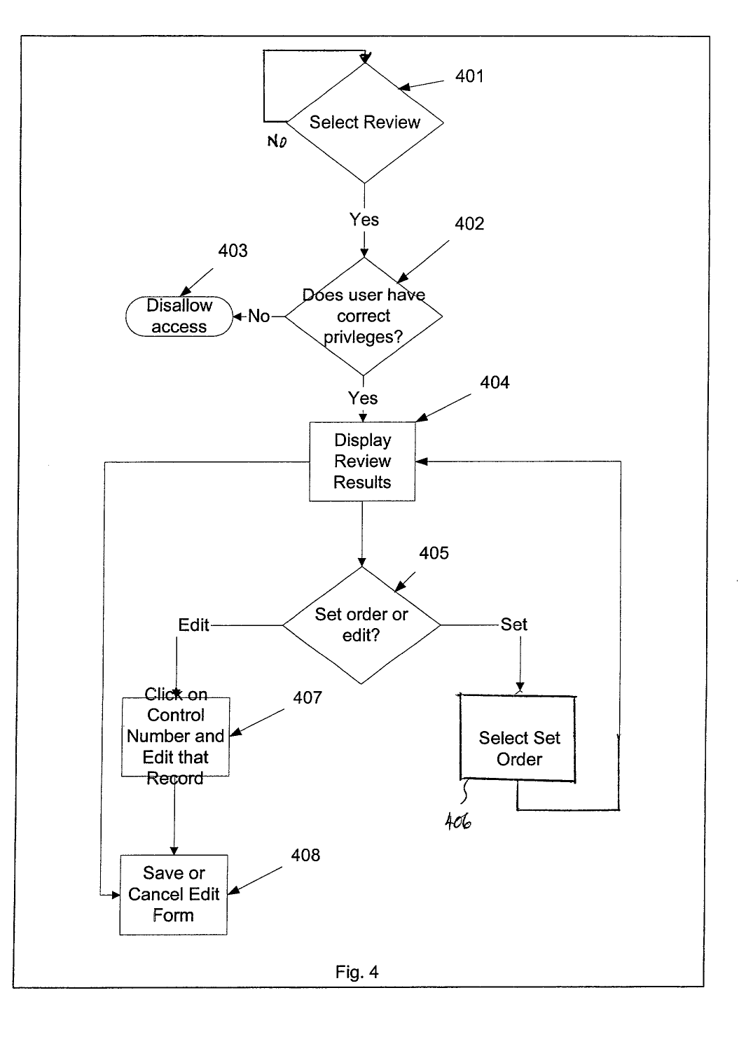

Referring now to FIG. 4, one example of implementing how status information (e.g., tasks and anomalies) is reviewed or edited depending upon the level of access that an individual has is illustrated in the flowchart shown. In the example shown, the individual is assumed to be of user type. When the user selects the Review Anomaly option (e.g., clicks on button 1202 of FIG. 12), OTIS 100 detects 401 a selection made and passes control to step 402. The privilege of the user is checked 402. Access is disallowed 403 if the privileged does not exist. One example of implementing this verification is for server 103 to invoke an SQL query of database 104 to determine whether access has been previously granted to the feature that the user is attempting to review. If sufficient privilege exists (e.g., Yes branch of 402), then access is granted and the results of the status information are retrieved from database 104 and displayed in step 404. Subsequently, a determination is made 405 as to whether the user wants to select the order in which the tasks and anomalies are to be reviewed or wants to proceed directly to editing the task or anomaly. If the order is to be changed, the user selects the order 406, and the information is reordered and then displayed in the selected order by returning to step 404. It is noted that the selection of the order can be a repetitive process (as shown) or a single control input selection, depending upon implementation choices. At step 405, if the user selects to edit the information displayed, the process continues in step 407. In step 407 editing is input at the client 102 (e.g., by a mouse at the workstation) and the information is sent over the network to the server 103. After making the necessary and allowed changes, the update (e.g., edit) is either saved in the database 104 or cancelled 408 based on user input.

### H. Tasks Overview

1. Data Entry

The aspect of the present invention concerning the tracking of tasks enables supervisors to assign recurring tasks to a position class or a specific position. If an individual assigned to a particular position is unavailable, another person may step into that position and will be able to know all the tasks of that day that needs to be completed in an easy and efficient manner using the present invention.

There are many types of tasks allowed. There are one-time tasks that will occur once and then be done with. There are also repetitive tasks. These repetitive tasks can be broken down into flexible or fixed. A task that is assigned as flexible will be allowed to move in time (e.g., a holiday's weekends, days off, etc.). A fixed task will not be allowed to move. Once a flexible or fixed indication is assigned to a task, the indication will stay assigned even if that day happens to be a holiday; and preferably, the indication should not be reassigned.

In accordance with the present invention, tasks as defined for OTIS 100 allow a person to assign tasks to a position. One example for implementing tasks includes the main tasks being stored in a table and every day a background process or program will go through and put all the current day's tasks in an auxiliary table. Once a task is completed it will stay in this table and become the log entry.

Users may input tasks for themselves, while it is preferable that managers can assign tasks to a position other than their position. In one embodiment in accordance with the present invention, the positions that managers are allowed to assign tasks to comprise those positions below them in the organization chart (e.g., to subordinates, like users).

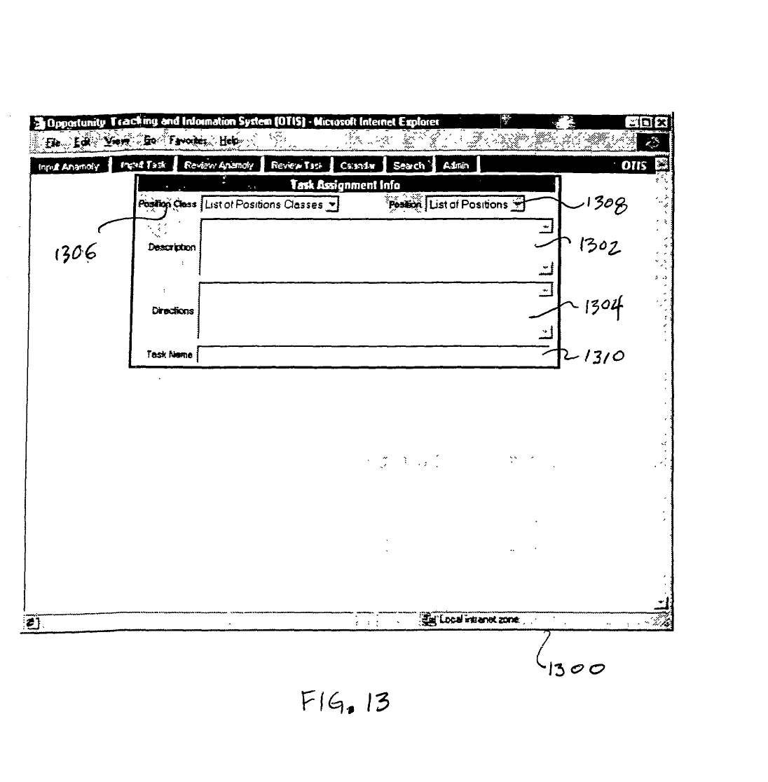

Reference is made to FIG. 13, which illustrates an example of a user interface 1300 that allows the user to enter the information about the task. In the example shown, the user can enter a detailed description 1302 of the task, and specific directions 1304 that are required to complete the task. Other fields shown in FIG. 13 include: an indication of the position class 1306, which may selected from a list provided in a drop-down menu bar; a position 1308, which the user may select from a list of all positions in the selected position class; and a task name 1310, which allows the naming of tasks for easier and quick referencing. Additionally, it is noted that the screen input shown in FIG. 13 is also available to a manager, and is a screen entry where a task can be assigned to a position class or a specific position.

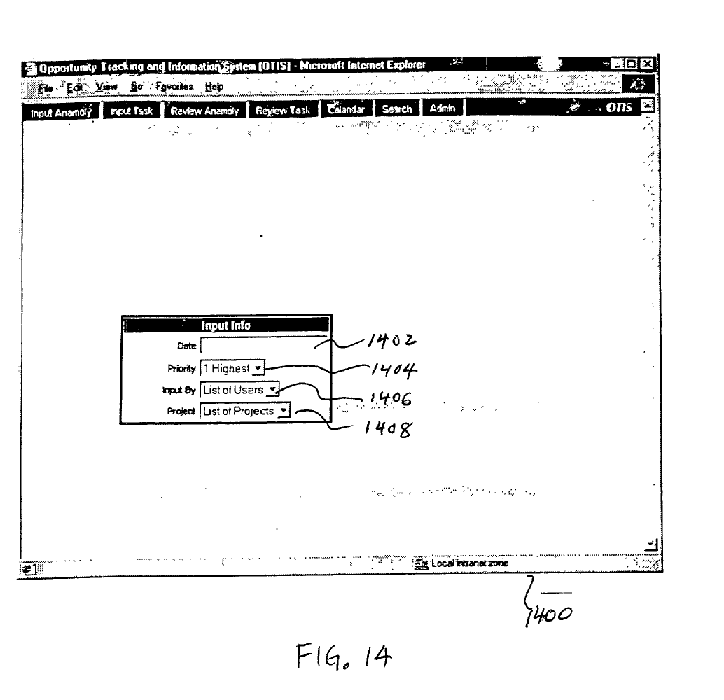

Additional examples of data entry in accordance with the present invention are now mentioned below. In FIG. 14, an example is shown of a user interface 1400 for inputting information used to track the date 1402 the task was inputted and the priority 1404 of the task. Additional fields that are shown in the example include the user name 1406 that entered the task and the project 1408 associated with the task.

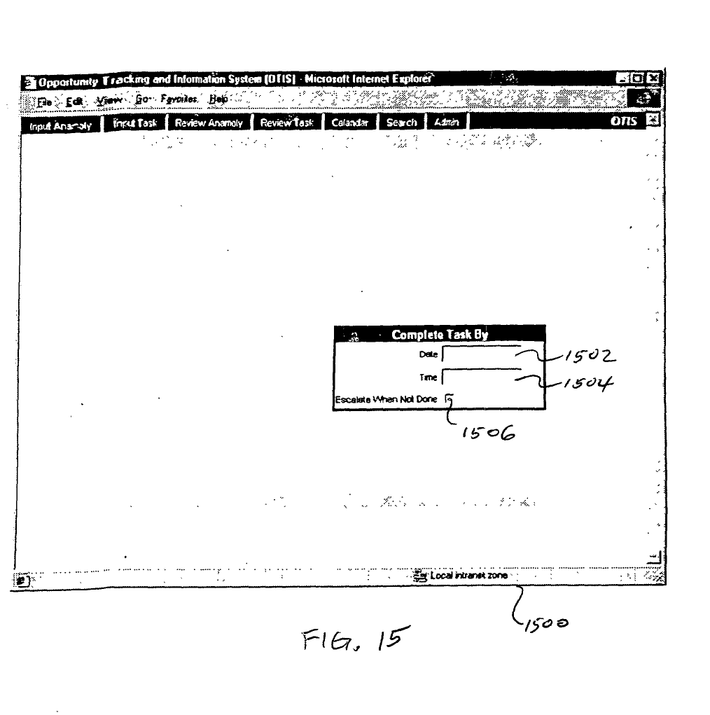

In FIG. 15, an example is shown of a user interface 1500 for the manager to assign the amount of time for a task once it is assigned to the position. Managers can determine if the task needs to be done by a certain date 1502 or time 1504 if, for example, the task can be resolved either in a one-time servicing or in a repetitive manner (e.g., a certain amount of days/hours, especially when a task is repetitive). Field 1506 entitled Escalate When Not Done permits the task to be escalated when it is not timely completed. The manager assigning the task may also assign the repeating time interval so that the system will send notification to the assignee. Additionally, once a task is escalated, the system 100 will notify the manager associated with the task that has been escalated according to a repeating time interval. This also allows for notification when the task is not completed.

FIG. 16 illustrates an example of a user interface 1600 where managers are allowed to check when they want email notification. In the example shown, the appropriate manager can receive email notification 1606 when the task is not completed on time 1602 or when the task was escalated 1604 to the next position defined in the organization chart.

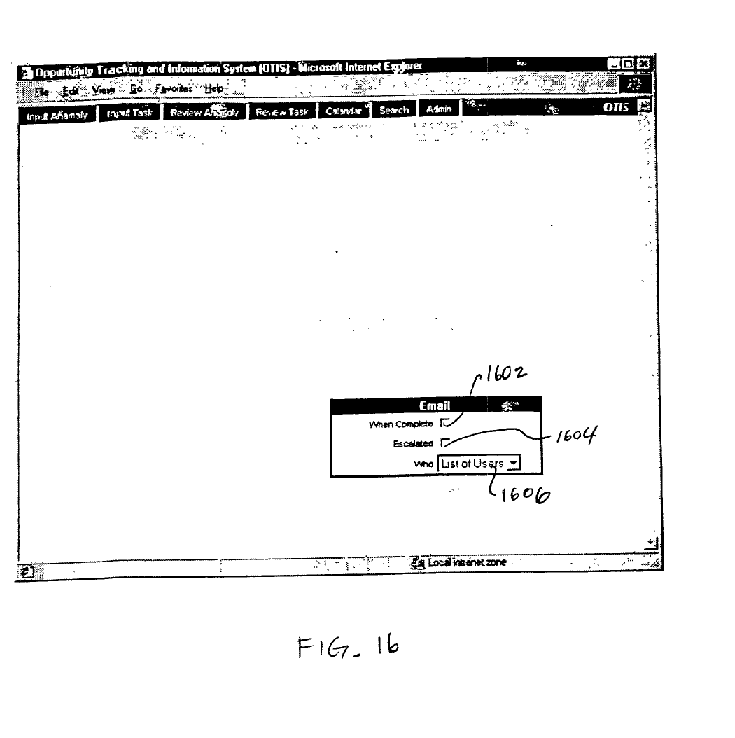

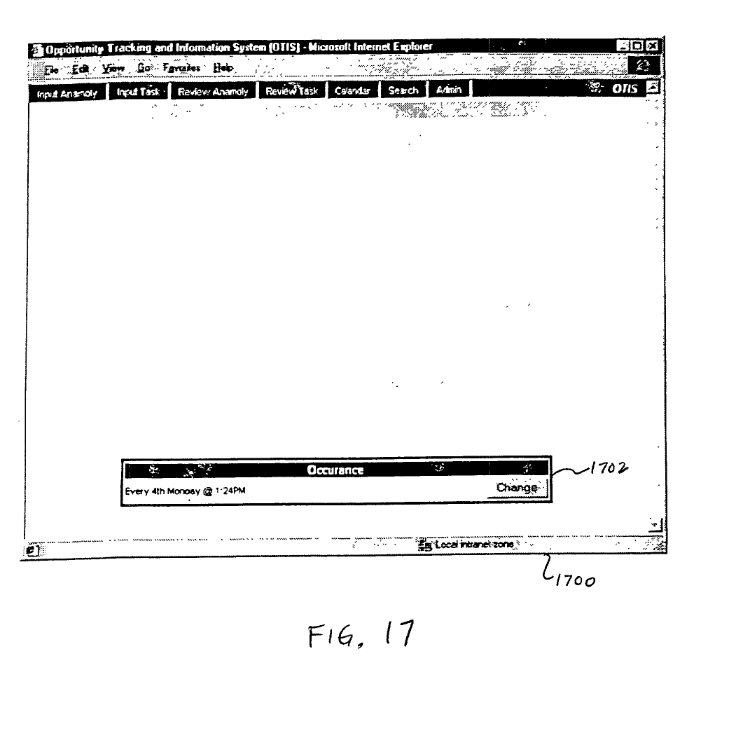

FIG. 17 illustrates an example of a user interface 1700 indicating 1702 the occurrence of a task on the input screen as a sentence. In FIG. 18, a dialog box allows the user to assign the occurrence of the task, for example, by selecting the month, week, day or hour that the task will occur and how often it will occur. This dialog box can be invoked if a “Change” button is clicked.

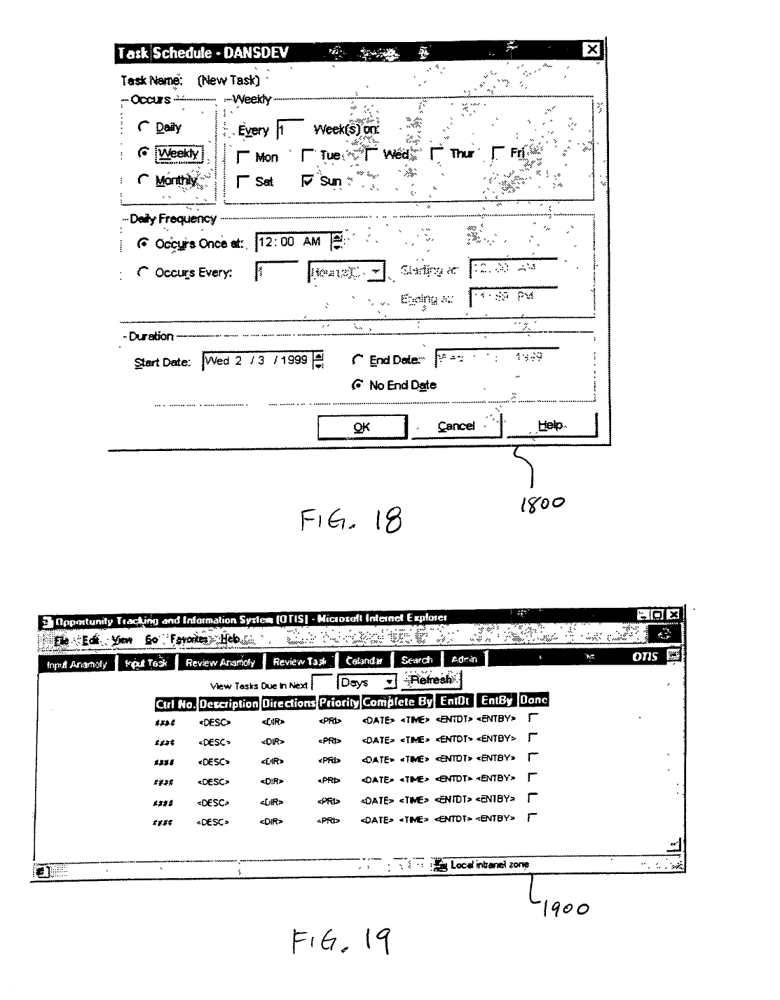

In FIG. 19, an example is shown of a user interface 1900 with a Review Tasks screen. In the example shown, a user can view and mark off tasks. The user can also restrict how many days ahead that tasks should be displayed for review. Additionally, the user is able to sort the columns. For example, columns can be sorted by priority or “complete by time” field. This screen is also used for managers to view all the master tasks and edit or delete them.

2. Escalation

A user interface for escalating a task that remains incomplete can also be included in accordance with the present invention. If the task requires escalation (i.e., determined by the inputting manager), and the task was not completed by the specified time, the task is escalated up to the next position as specified in the organization chart. Email notification can happen at every step that the task is escalated up or the inputting manager can select notification only when the task reaches a certain position. In either case, the email is sent to the positions specified. If a user cannot complete a task, an explanation may be given in that particular task log. This will mark it done (e.g., completed) by the system 100 and escalation will not occur. Notification will be e-mailed to the position specified.

3. Task Templates

Task templates allow a manager to group tasks together and create a template that can be assigned to a new project. Each of the tasks within the template is assigned to the specified position classes and specified occurrence per the requirements of the template. Once a template is created and assigned, the manager can still go into the template and add a task or anomaly at anytime.

When the template is created, the managers are able to use any of the tasks or multiple tasks that are already in the system 100. The managers may also use any templates within OTIS 100. The template will generally not use the information comprising the occurrence of the task or whom the task is assigned to. The manager assigns this information separately for the template. It is preferred that the manager assign the task to a position class, so the task may be later assigned to different positions in the position class.

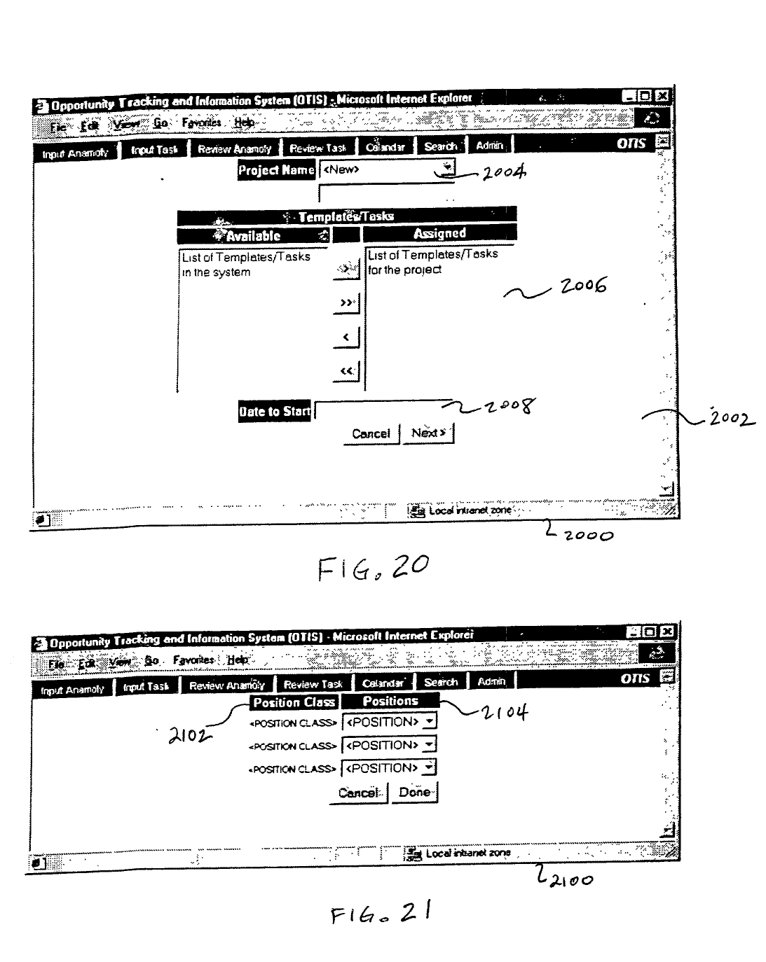

Referring to FIG. 20, an example is shown of a user interface 2000 for the manager to assign the task, wherein a wizard 2002 will pop up. In the example shown, the manager S assigns the project and if one is not in the list, the manager may add a new project 2004. The manager also assigns 2006 all the templates and tasks that are desired for this particular project as well as the start date 2008 of the project.

In FIG. 21, an example is shown of a user interface 2100 (e.g., a second screen of the wizard) that lists all the position classes 2102 in the template and positions 2104 within the class that the tasks can be assigned to. Any position in the tasks will automatically be given rights to the project.

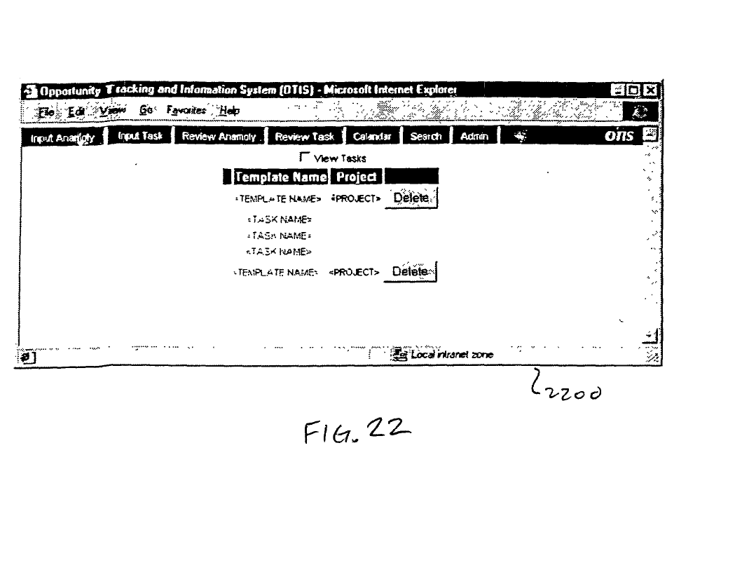

FIG. 22 illustrates an example of a user interface 2200 that enables a manager to review all the templates that exist for projects for which they are assigned. Additionally, administrators can use interface 2200 to view all of the templates for the system. With the example shown, these two types of individuals, managers and administrators are able to view the templates by name or by clicking on a checkbox at the top to allow viewing of the tasks or templates assigned to the template. The user interface 2200 also provides the manager with the ability to edit or delete the template. If the template is deleted, only the template gets deleted. None of the tasks in the template are deleted as the tasks are deleted separately.

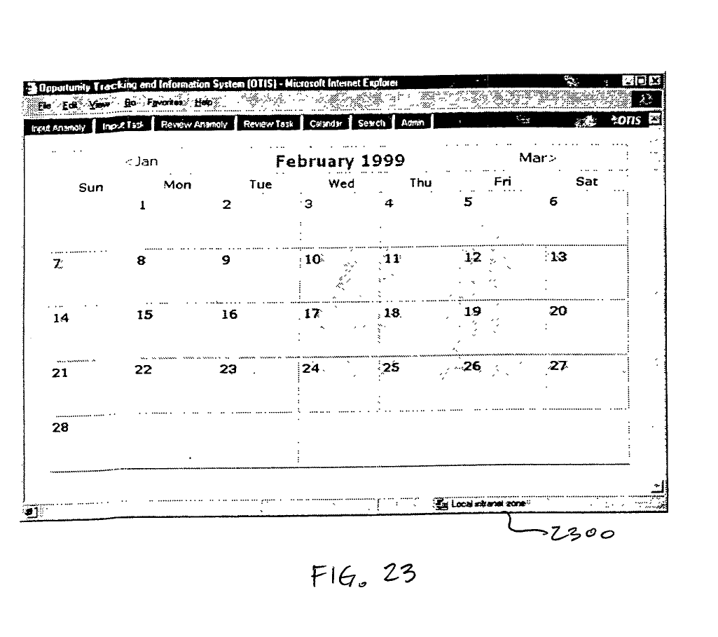

From anywhere in OTIS 100, the individuals can click on the calendar option from the menu and be taken to the calendar screen, which is shown in the user interface 2300 of FIG. 23. There they will be able to see their tasks on the calendar.

With the month view option, the individuals can see their tasks and the estimated fix days laid out on a monthly calendar. In one embodiment, the days with an anomaly estimated fix date being within the next two days are shown red. Also, any anomaly with a priority of three or more is indicated in red on the month for clarity and focus. The user may go forward and see their tasks as well as backwards.

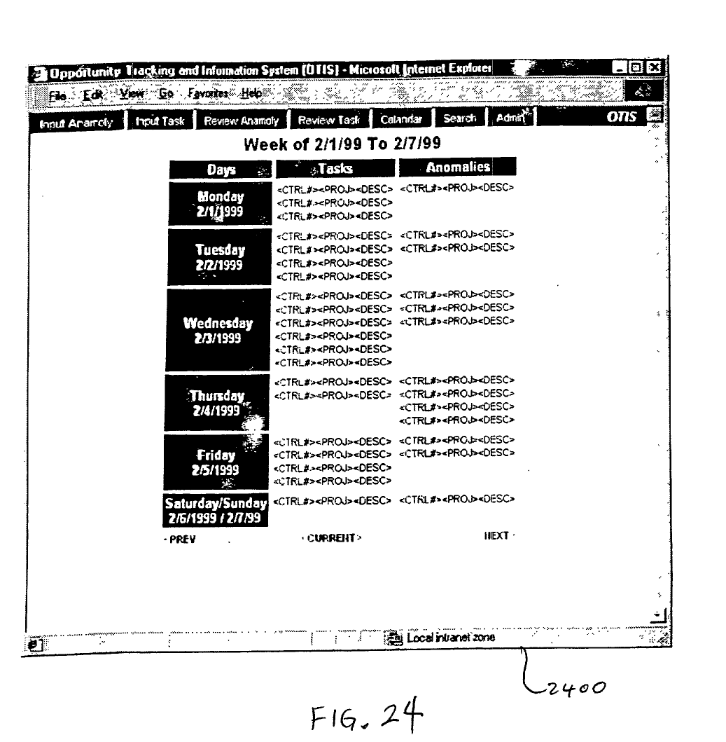

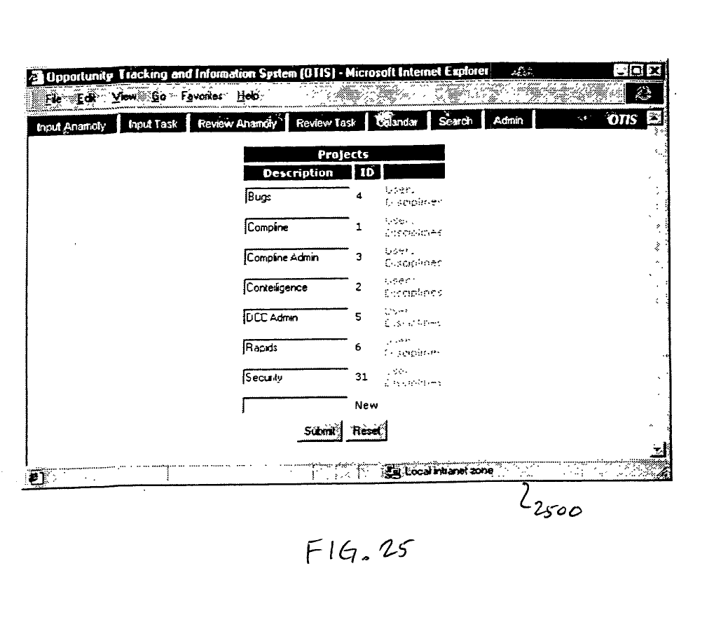

In another embodiment in the nature of the weekly view, as seen in the user interface 2400 of FIG. 24, the user is also able to view anomalies and tasks on a weekly basis. In the example shown in FIG. 24, the control number is displayed in the table and linked to the anomaly or task. Clicking on the link will take the user to that task or anomaly.

### I. General Administration

One aspect of the present invention is that OTIS 100 is embodied as a web site accessible on an intranet, which is maintained through administrative features of the web site. The administrative portions of the web site are accessible only to those individuals being administrators, who can enter in new projects and assign users and disciplines to that project. FIG. 25 shows an example of a user interface 2500, where administrators can enter this information. All of the project names are maintained and new ones can be added. For each project, the administrator preferably assigns the disciplines and the users allowed on that project.

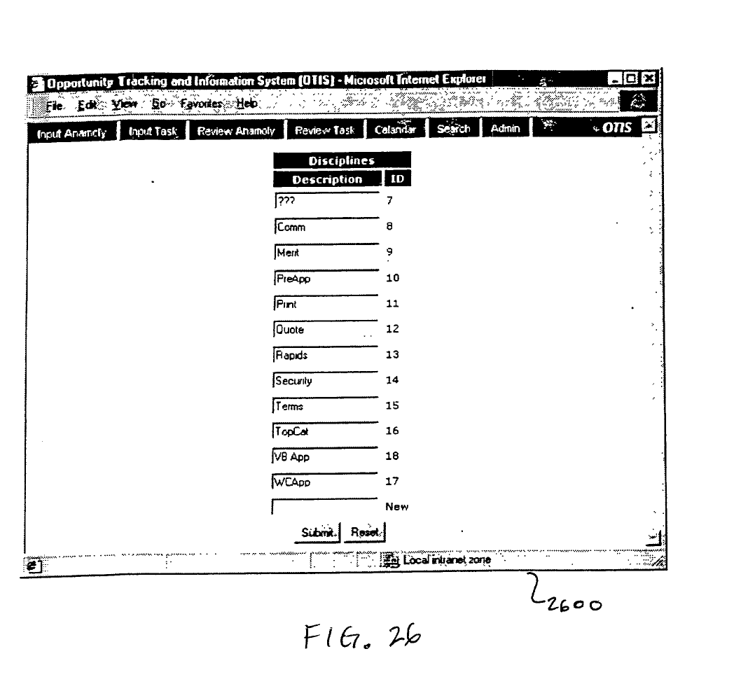

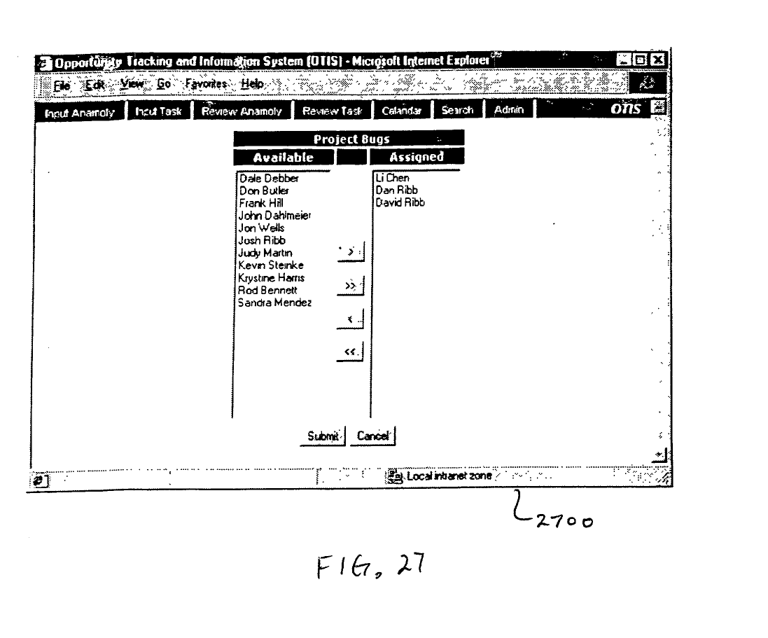

FIG. 26 illustrates an example of a user interface 2600 where the disciplines are assigned to a project. In the example shown in FIG. 26, the discipline breaks down the specific categories in the project. This helps narrow the location of the anomaly within the project. The disciplines can be designed not to be global.

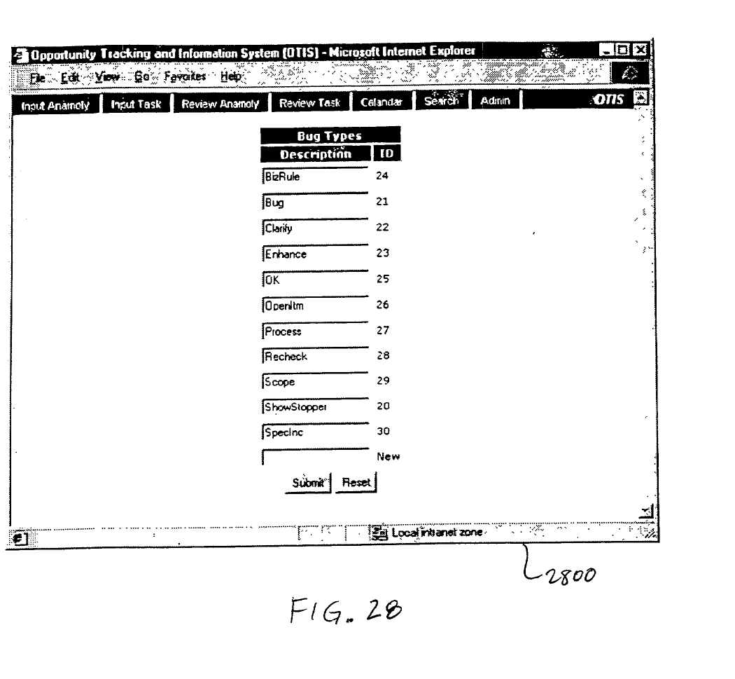

In FIG. 27, an example of a user interface 2700 is shown. In the example, the administrator can add users to the project for them to view and add the anomalies, as well as edit the anomalies. The administrator can add users that have rights and who are preprocessed within the security system of OTIS 100.

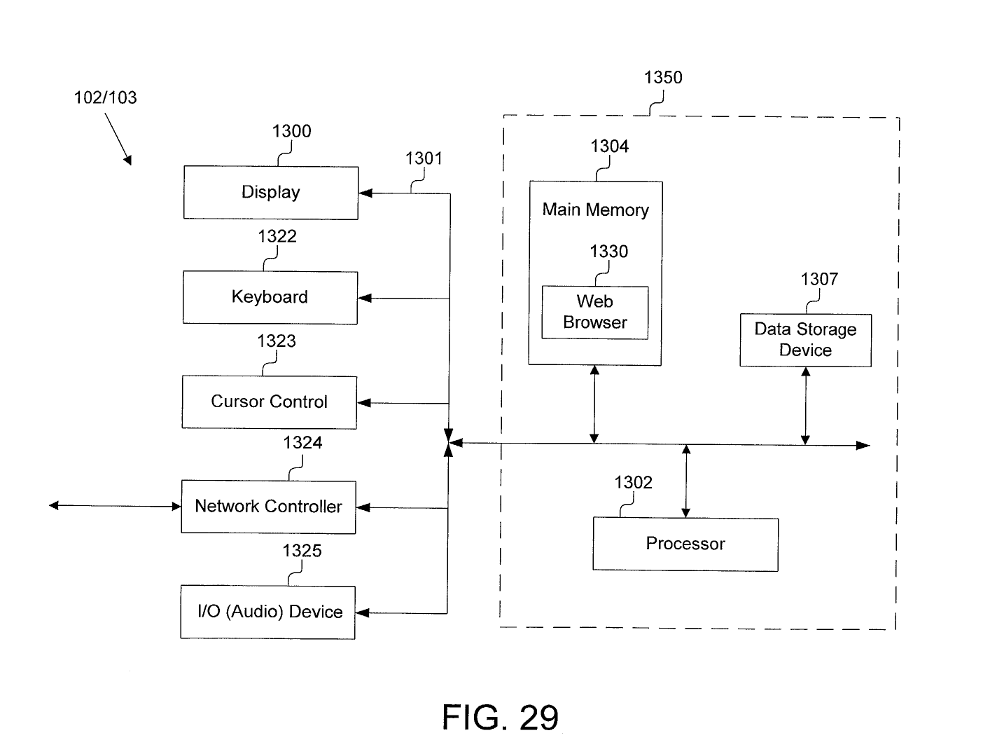

FIG. 28 illustrates an example of a user interface 2800 listing all of the anomaly types that are maintained and the new ones that are added. In the example shown, the anomaly types preferably are global so they pertain to all the projects with OTIS 100. Other types of administrative functions in accordance with the present invention will now be discussed. For example, the position names are maintained and new ones are added with one aspect of the present invention. Once a position is added, users in the security system must be added to the positions. Generally, one user is assigned to a position, but a user may be assigned to multiple positions. Once positions are created they are then placed in classes. Multiple classes can share one position.

An additional administrative function concerns the organization chart. This chart allows the administrator to define the structure of those positions within an organization like a company. All positions can be shown in a tree format, and the administrator may move the position around and reassign the parent of a position. The same position may also be assigned to multiple parents.

Yet another administrative function comprises the Reports and logs. Those individuals being of the type having manager and administrator rights can view the reports and logs. For example, several user activities that are logged in accordance with the present invention include: (1) login; (2) adding or editing of an anomaly or task; (3) marking or signing off of an anomaly or task; (4) escalation of tasks; (5) creation, assignment, and editing of templates; and (6) all administration functions.

Additionally, a manager can see in a tabular view of rows and columns like a spreadsheet of those tasks that have been escalated and to whom. A manager can further view all anomalies that have been assigned and are past the estimated fix date.

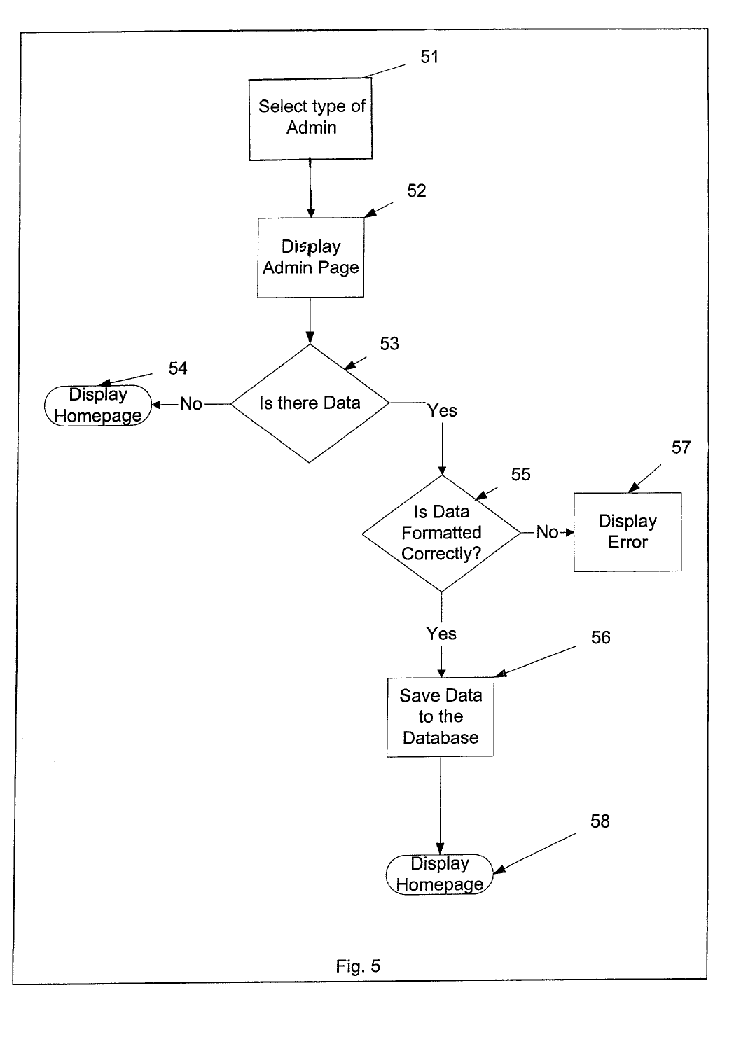

Reference is now made to FIG. 5, which illustrates a flowchart showing an example of a process for providing status information concerning the administrative features, and for incorporating updates thereto. At step 51, the type of administrative function is selected by the user, whereupon server 103 queries database 104 to retrieve corresponding information so that a display screen such as a web page can be formatted with the administrative status information and sent to client 102 for display 52 thereon. Control then passes to step 53, where a determination 53 is made as to whether there exists data input by an individual. If there is no data, then a default screen such as the home page is displayed 54. Otherwise, if there is data, then control passes to step 55. At step 55, a determination is made as to whether the data is formatted correctly. If not, then an error message is displayed 57. However, if the data is formatted correctly, then server 103 saves the data 56 in database 104. Thereafter, the default screen such as home page is displayed 58 populated with the updated information.

While the invention has been described in conjunction with the described embodiments, it is evident that many alternatives, modifications and variations will be apparent to those skilled in the art in light of the foregoing description. Accordingly, the disclosure of the present invention is intended to be illustrative, but not limiting, of the scope of the invention, which is set forth in the following claims.

What is claimed is:

1. A computer-implemented method for managing tasks, the method comprising steps of:
accessing a first server from a client;
retrieving by the first server status information associated with tasks stored on a database for display to the client;
receiving an instruction for managing the tasks;
responsive to the instruction received, generating updates to the status information; and
providing the status information as updated for display at the client.

2. The computer-implemented method of claim 1, further comprising the step of encapsulating functions associated with the tasks as programmable objects.

3. The computer-implemented method of claim 1, wherein the tasks comprises a plurality of attributes selected from a group comprising a description, a completion date, a priority indicator, a duration indicator, an originator, and an assignee.

4. The computer-implemented method of claim 3, wherein the step of generating updates to the status information comprises the sub-steps of:
tracking a completion date associated with at least one of the tasks;
determining a failure to complete the at least one task by the completion date corresponding thereto; and
providing notification of the failure.

5. The computer-implemented method of claim 4, wherein providing notification comprises the sub-steps of:
determining an assignee having responsibility for completing the task for which failure was determined; and
forwarding a notification to a manager associated with the assignee.

6. The computer-implemented method of claim 3, further comprising the steps of:
determining whether a user instruction is associated with an authorized user; and
responsive to a determination that the user instruction is associated with an authorized user, modifying the status information based on the user instruction.

7. The computer-implemented method of claim 1, wherein the step of generating updates to the status information comprises the sub-steps of:
modifying the status information based on the user instruction; and
storing modified status information in the database.

8. The computer-implemented method of claim 7, wherein the step of modifying the status information comprises the sub-steps of:
determining a class associated with a group of tasks;
verifying that the class includes a parameter enabling modification of the status information; and
responsive to verification that the class includes a parameter enabling modification, modifying the status information in accordance with the parameter.

9. The computer-implemented method of claim 8, wherein the class is selected from a group comprising users, managers, and administrators.

10. The computer-implemented method of claim 9, further comprising the step of associating access permission with the parameter by an administrator.

11. The computer-implemented method of claim 9, further comprising the step of assigning tasks to a selected user.

12. The computer-implemented method of claim 9, wherein the status information indicates to the users the tasks to be completed.

13. The computer-implemented method of claim 9, wherein the status information indicates to the managers the tasks that are overdue.

14. The computer-implemented method of claim 1, wherein the user instruction is selected from a group comprising an update to a task, and creation of a new task.

15. The computer-implemented method of claim 1, further comprising the steps of:
maintaining a representation of the status information on the first server;
modifying the status information with the updates; and
storing the modified status information to the database.

16. A method for integrating status information with updated information, the method comprising the steps of:
accessing an account in response to an instruction received from a user;
receiving the status information associated with the account from a database;
receiving the updated information for modifying the status information from the user; and
forming a combined presentation of the status information modified by the updated information, wherein the combined presentation includes a representation of the status information received from the database and a representation of the updated information.

17. The method of claim 16, further comprising the step of transferring the combined presentation to a client computer for display.

18. The method of claim 16, further comprising the step of storing the status information modified by the updated information on the database.

19. The method of claim 17, wherein the status information comprises a plurality of tasks and a plurality of anomalies.

20. The method of claim 19, further comprising the steps of:
assigning a completion date to a first one of the tasks;
determining whether the first one of the tasks was completed by the completion date;
indicating that the first one of the tasks is an incomplete task if it is determined that the first one of the tasks was not completed by the completion date; and
providing notification of the incomplete task to an additional account for initiating follow up.

21. The method of claim 20, wherein the step of providing notification of the incomplete task comprises the sub-steps of:
determining a user associated with the account having responsibility for completing the incomplete task; and
transmitting the notification to the additional account assigned to a manager associated with the user.

22. The method of claim 19, wherein accessing an account in response to an instruction received from a user comprises the sub-steps of:
receiving a user identification number and a password from the instruction;
accessing the database to authenticate the user identification number and the password; and
responsive to the user identification number and the password being authenticated, enabling access to the account.

23. The method of claim 22, further comprising the sub-step of generating an error message for display on the client computer responsive to the user identification number and the password being unauthenticated.

24. The method of claim 19, wherein the step of receiving the status information associated with the account comprises the sub-steps of:
extracting state information from the instruction; and
determining whether a user-defined display format is associated with the state information exists.

25. The method of claim 24, further comprising the sub-steps of:
responsive to determining that the user-defined display format exists, retrieving the user-defined display format from the database; and
determining whether the user-defined display format is associated with one or more of the tasks and the anomalies.

26. The method of claim 25, further comprising the step of incorporating the user-defined display format with the tasks and the anomalies in the combined presentation in response to the user-defined display format being associated with the tasks and the anomalies.

27. The method of claim 25, further comprising the step of incorporating a default display format in the combined presentation responsive to the user-defined display format being un-associated with the tasks and the anomalies.

28. The method of claim 24, further comprising the sub-step of:
responsive to determining that the user-defined display format does not exist, retrieving a default display format from a server; and
extracting the tasks and the anomalies associated with the user from the database.

29. The method of claim 28, further comprising the step of incorporating the tasks and the anomalies extracted with the default display format in the combined presentation.

30. The method of claim 16, wherein the combined presentation includes at least one form for representing the status information.

31. The method of claim 16, wherein accessing an account in response to an instruction received from a user comprises the sub-steps of:
processing requests received in the instruction to identify the user; and
coordinating the requests in order to access and control the account.

32. A computer-implemented method for tracking work flow information, the method comprising the steps of:
accessing an account on a server from a client by a user;
displaying the work flow information in response to accessing the account according to the position of the user;
modifying the information with updates; and
storing the information modified to the database.

33. The computer-implemented method of claim 32, wherein the information displayed is selected from a group comprising tasks to be completed, and anomalies that are incomplete.

34. The computer-implemented method of claim 33, further comprising the steps of:
assigning each of the task a serial number; and
identifying each of the tasks by the serial number corresponding thereto when the information is received.

35. The computer-implemented method of claim 32, further comprising the step of selecting an order in which the information is displayed.

36. The computer-implemented method of claim 33, wherein the account is associated with a user selected from a group comprising users, managers, and administrators.

37. The computer-implemented method of claim 36, wherein step of modifying the information with updates includes a user defining an anomaly associated with the work low information.

38. The computer-implemented method of claim 37, wherein the step of modifying the information with updates includes a manager assigning at least one of the users the anomaly for rectification.

39. A system for tracking status information, comprising:
a server for accessing an account in response to an instruction received from a client device communicatively coupled to the server;
coupled to the server, a database for providing the status information associated with the account based on the instruction received;
a module for maintaining a copy of the status information on the server; and
a module for forming a combined presentation of the copy of status information and updates provided by the client device.

40. A computer program product for deriving services through one or more accounts from a database, the computer program product stored on a computer readable medium, and adapted to perform the operations of:
accessing the accounts at a server in response to user instructions received;
the server extracting status information from the databases for a plurality of tasks associated with the online account;
updating the status information based on the user instructions; and storing the status information updated on the databases.

42. A program product for tracking completion of tasks from at least one account, the program product stored on a computer readable medium and adapted to perform the operations of:
accessing the account through sign-on over a first server;
responsive to user input, selecting particular ones of the tasks for viewing status information corresponding thereto;
providing updates for the status information, the updates related to completion of the particular ones of the tasks; and
storing the updates for the status information to the online account.
